(19) United States
(12) Patent Application Publication
(10) Pub. No.: US 2025/0326669 A1
(43) Pub. Date: Oct. 23, 2025

(54) METHODS OF TREATING OIL SANDS PROCESS-AFFECTED WATER WITH ALGAE AND USES THEREOF

(71) Applicant: Joseph FIDA, East Garafraxa (CA)

(72) Inventor: Joseph FIDA, East Garafraxa (CA)

(21) Appl. No.: 18/870,593

(22) PCT Filed: May 31, 2023
(86) PCT No.: PCT/CA2023/050747

§ 371 Date: Nov. 29, 2024

Related U.S. Application Data
(60) Provisional application No. 63/347,229, filed on May 31, 2022.

(51) Int. Cl. C02F 3/32; C02F 101/34; C02F 103/36

(52) U.S. Cl. CPC C02F 3/322; C02F 2101/34; C02F 2103/365; C02F 2209/02

(57) ABSTRACT

The present disclosure provides a method and use of green and blue-green algae for treating oil sands process-affected water (OSPW), to biodegrade naphthenic acids in the OSPW. The method comprises obtaining irradiated OSPW, combining the irradiated OSPW with blue-green algae or green algae to form a mixture, and applying light to the mixture. The irradiated OSPW may be OSPW that was irradiated with gamma or electron-beam irradiation. Light and heat may be applied to enhance the method and use.

### FIELD

The present disclosure is related to a method and use for treating oil sands process-affected water (OSPW). In particular, the present disclosure is related to a method and use of green algae and blue-green algae to treat the oil sands process-affected water to reduce naphthenic acids.

### BACKGROUND

For decades, the oil production operations in the Albertan oil sands have been accumulating OSPW in tailing ponds. Unlike in traditional extraction methods that inject steam into oil wells before pumping it out, extracting oil from the tar sands involves a much more water-intensive process. One of the most common methods is hot water extraction, which utilizes a ratio of 15-20 times more fresh water to oil extracted, in addition to numerous solvents and catalysts (Saidi-Mehrabad, et al., 2013). The major issue is that the resulting water (OSPW) is now highly toxic and cannot be reintroduced into Athabasca's water table in its current state. The liquid tailings, or OSPW, is instead stored in man-made reservoirs (i.e. tailing ponds) (Cabrera, 2008).

Some of the major environmental concerns relating to the tailing ponds include organisms (such as animals) coming into contact with the man-made reservoirs, and seepage of the OSPW into the Athabasca water table. The combination of the lack of enforcement of regulations, coupled with previously inconclusive evidence of seepage, has allowed the tailing ponds to continue to grow. It is estimated that in 1993, there was 300 million m³ of liquid tailings with an accumulation rate of 0.1-0.2 m³ of tailings per tonne of oil sand processed. In 2019, the Natural Resources Defense Council estimated there to be 1.525 billion m³ of tailings accumulated.

The toxic constituents commonly found in the tailings include: toxic heavy metals, naphthenic acids (NAs), and polycyclic hydrocarbons (Saidi-Mehrabad, et al., 2013). The most problematic contaminant in the tailings is the NAs. This is due to the difficulties associated with trying to remove them, as they are highly soluble in the aqueous phase. The NAs not only pose a risk to the ecosystem, but also pose an operational risk to the oil production itself. When recycled aqueous phase tailings (with elevated NA levels) are used, at temperatures past 230° C., they become considerably more corrosive and can cause mechanical failures of the distillation equipment (Quagraine, et al., 2005).

The detriments of the OSPW has been known for decades and numerous attempts have been made to find effective treatment solutions (Allen, 2008). Known methods include using (1) adsorbents, (2) membranes/filtration, (3) biological treatment, (4) advanced oxidation, and (5) constructed treatment wastelands. These methods have achieved differing degrees of success, but generally suffer from incomplete pollutant removal, fouling from oil, high operational costs, use of harmful solvents, and/or production of other undesirable outputs.

### SUMMARY

In various examples, the present disclosure describes methods and uses of green algae and blue-green algae for treating oil sands process-affected water (OSPW).

In some examples, the present disclosure describes a method of treating OSPW, the method comprising: obtaining irradiated OSPW; combining the irradiated OSPW with blue-green algae, green algae, or a combination thereof to form a mixture; and applying light to the mixture.

In some examples, the present disclosure describes a use of blue-green algae, green algae, or a combination thereof to treat irradiated oil sands process-affected water (OSPW).

In any of the above examples, the blue-green algae or green algae biodegrade naphthenic acids in irradiated OSPW and biomass of the blue-green algae or the green algae is generated.

In any of the above examples, the blue-green algae is Spirulina platensis, and the green algae is Dunaliella tertiolecta.

In any of the above examples, light is applied to the mixture at an intensity between 1.5 and 3 W/L, and preferably at an intensity of 3 W/L.

When the irradiated OSPW is combined with the Spirulina platensis, the mixture is be heated to a temperature between 25 and 35° C., and preferably to 32° C.

When the irradiated OSPW is combined with the Dunaliella tertiolecta, the mixture is be heated to a temperature between 25 and 35° C., and preferably to 25° C.

In any of the above examples, obtaining the irradiated OSPW comprises irradiating oil sand-process affected water. The OSPW may be irradiated with gamma radiation or electron-beam irradiation.

When the irradiated OSPW is also ozonated.

### BRIEF DESCRIPTION OF THE DRAWINGS

Reference will now be made, by way of example, to the accompanying drawings which show example embodiments of the present application, and in which:

FIG. 1 is a flowchart illustrating a method for treating oil sand-process affected water according to examples of the present disclosure;

FIG. 2 is a schematic of a bioreactor set-up in a closed configuration for applying the method FIG. 1 in the Comparative Study;

FIG. 3 is a schematic of the bioreactor set-up of FIG. 2 in an open configuration with a LED panel visible;

FIG. 4 is a schematic of a bucket reactor set-up in a closed configuration for applying the method of FIG. 1 in the Large-Scale Study;

FIG. 5 is a bottom view of the lid of FIG. 4 in isolation;

FIG. 6 is a graph illustrating cell counts for Dunaliella tertiolecta at different temperatures of 25 or 32° C. (F/2 Media and 1.65 W/L);

FIG. 7 is a graph illustrating cell counts for Dunaliella tertiolecta at different temperatures of 25 or 32° C. (F/2 Media and 3.0 W/L);

FIG. 8 is a graph illustrating cell counts for Dunaliella tertiolecta at different light intensities of 1.65 W/L or 3.0 W/L (F/2 Media and 25° C.);

FIG. 9 is a graph illustrating cell counts for Dunaliella tertiolecta at different light intensities of 1.65 W/L or 3.0 W/L (F/2 Media and 32° C.);

FIG. 10 is a graph illustrating cell counts for Dunaliella tertiolecta at different temperatures of 25 or 32° C. (Irradiated OSPW Media and 1.65 W/L);

FIG. 11 is a graph illustrating cell counts for Dunaliella tertiolecta at different temperatures of 25 or 32° C. (Irradiated OSPW Media and 3.0 W/L);

FIG. 12 is a graph illustrating cell counts for Dunaliella tertiolecta at different light intensities of 1.65 W/L or 3.0 W/L (Irradiated OSPW Media and 25° C.);

FIG. 13 is a graph illustrating cell counts for Dunaliella tertiolecta at different light intensities of 1.65 W/L or 3.0 W/L (Irradiated OSPW Media and 32° C.);

FIG. 14 is a graph illustrating cell counts for Spirulina platensis at different temperatures of 25 or 32° C. (Zorrouk Media and 1.65 W/L);

FIG. 15 is a graph illustrating cell counts for Spirulina platensis at different temperatures of 25 or 32° C. (Zorrouk Media and 3.0 W/L);

FIG. 16 is a graph illustrating cell counts for Spirulina platensis at different light intensities of 1.65 W/L or 3.0 W/L (Zorrouk Media and 25° C.);

FIG. 17 is a graph illustrating cell counts for Spirulina platensis at different light intensities of 1.65 W/L or 3.0 W/L (Zorrouk Media and 32° C.);

FIG. 18 is a graph illustrating cell counts for Spirulina platensis at different temperatures of 25 or 32° C. (Irradiated OSPW Media and 1.65 W/L);

FIG. 19 is a graph illustrating cell counts for Spirulina platensis at different temperatures of 25 or 32° C. (Irradiated OSPW Media and 3.0 W/L);

FIG. 20 is a graph illustrating cell counts for Spirulina platensis at different light intensities of 1.65 W/L or 3.0 W/L (Irradiated OSPW Media and 25° C.);

FIG. 21 is a graph illustrating cell counts for Spirulina platensis at different light intensities of 1.65 W/L or 3.0 W/L (Irradiated OSPW Media and 32° C.);

FIG. 22 is a half-normal plot of effects from Dunaliella tertiolecta experiments grown in irradiated OSPW in the Comparative Study;

FIG. 23 is a pareto chart of the ranked effects from Dunaliella teritolecta experiments grown in irradiated OSPW in the Comparative Study;

FIG. 24 is a contour optimization chart for cell count at temperatures (25 through 32° C.) and light intensities (1.65 through 3.0 W/L) for Dunaliella tertiolecta Comparative Study experiments grown in irradiated OSPW;

FIG. 25 is a half-normal plot of effects from Spirulina platensis experiments grown in irradiated OSPW in the Comparative Study;

FIG. 26 is a pareto chart of the ranked effects from Spirulina platensis experiments grown in irradiated OSPW in the Comparative Study;

FIG. 27 is a contour optimization chart for cell count at temperatures (25 through 32° C.) and light intensities (1.65 through 3.0 W/L) for Spirulina platensis Comparative Study experiments grown in irradiated OSPW;

FIG. 28 is a graph showing cell count and dry cell weight for Spirulina platensis grown in irradiated OSPW media over the trial period of the large-scale study at a temperature of 32° C. and light intensity of 3 W/L.

Similar reference numerals may have been used in different figures to denote similar components.

### DESCRIPTION OF EXAMPLE EMBODIMENTS

Tailing slurry is the affluent stream from the oil sand oil production and contains sand, dispersed fines, residual bitumen and water. The tailing ponds can be broken down into three main levels: (1) the bottom most layer which is often referred to as the “mature fine tailings”, (2) the middle layer, often referred to as the “immature fine tailings”, and (3) the topmost layer which is the “free water zone”, which may be recycled and reused in the oil production process. The toxic constituents commonly found in the tailings include toxic heavy metals, naphthenic acids (NAs), and polycyclic hydrocarbons. The most problematic are the NAs, as they are highly soluble in the aqueous phase. Thus, the primary areas that the present disclosure will be targeting are the top and middle layers of the tailing slurry, though the present methods and uses may be applied to most bodies of water contaminated with NAs.

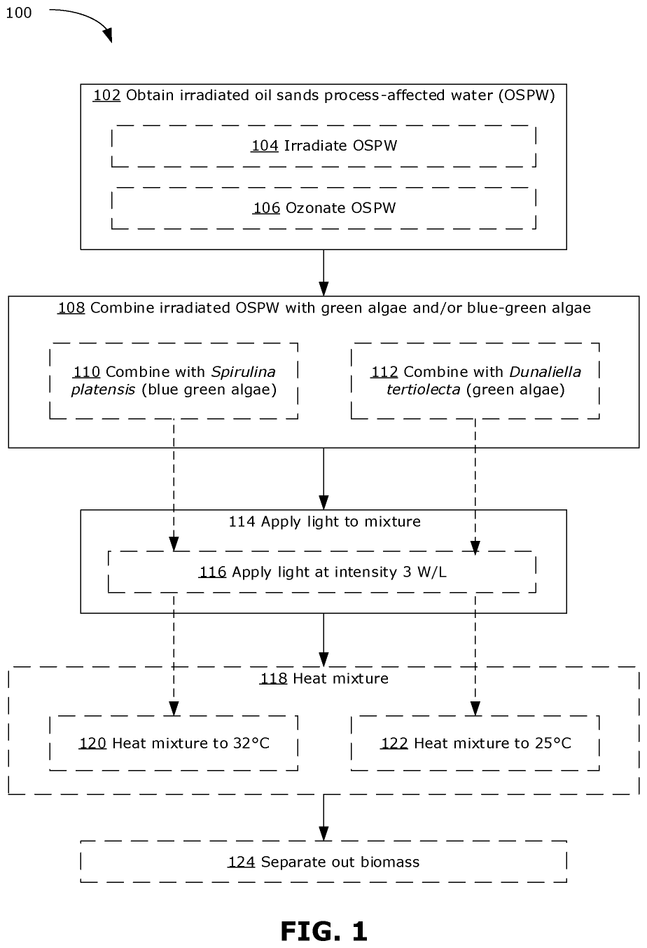

Referring to FIG. 1, a method 100 is shown illustrating a process for treating oil sands process-affected water (OSPW) according to examples of the present disclosure. Objectives of the disclosed method and use include minimizing the naphthenic acid (NA) content in the OSPW while also maximizing algal biomass production.

As mentioned above, OSPW is the effluent resulting from oil sands production operations, which frequently include NAs. NAs are a family of pollutants, comprising a mixture of several cyclopentyl and cyclohexyl carboxylic acids that are highly soluble in the aqueous phase. The most toxic of these are those that are highly alkylated. Depending on the degree of hydrogen deficiency, these soluble acids can have varying degrees of cyclicity. A certain fraction of the population can be highly cyclical, making them resistant to degradation. Thus, if the soluble acids were broken down, this would allow for more effective biodegradation to be achieved downstream in the process. One way of breaking down the cyclicity of these soluble acids is through irradiation.

Thus, at 102, irradiated OSPW is first obtained. In some applications, the OSPW input may have been previously irradiated by a third-party, and acquired as irradiated OSPW. The irradiated OSPW may, thus, be one of the inputs.

In other applications, optionally at 104, the OSPW may be irradiated to break down the cyclicity of the NAs. For example, the OSPW from the immature fine tailings and free water zone may be collected and irradiated with gamma radiation or electron-beam (E-beam) irradiation. Alternatively, a UV light with a photocatalyst, such as Titanium Oxide, can be used to irradiate.

E-beam irradiation is a form of ionizing radiation that relies on a magnetic gun to accelerate free electrons via negative beta decay processes. This occurs by heating a cathode filament, exciting valence electrons so they become unbound, and are then accelerated down a vacuum tube due to a voltage gradient created by a downstream anode. With the E-beam collimated and, thus, the precise kinetic energy known, it will be directed at an oncoming stream of OSPW. These high energy electrons interact with the OSPW to produce a variety of highly reactive, transient radicals. Depending on the reaction pathway, these radicals can slightly vary. However, the most important and abundant of these radicals is the hydroxyl radical (Le Caër, 2011). This process is known as water radiolysis. Through the use of E-beam to create free radicals, advanced oxidation reactions are facilitated to help breakdown molecules that would prove otherwise very difficult to do so, such as highly cyclical NA structures.

However, with E-beam irradiation, the further away from the source of the irradiation, the weaker the concentration and therefore the weaker the impact. This is known as the “dose effect”. The main cause of dose effect arises from the radicals, produced from radiolysis, being scavenged by “side reactions” with other compounds in the solution. The relevance of this is that the loss of the scavenged solvated electrons and hydrogen radicals tends to result in lower overall yields of hydroxyl radical.

Thus, optionally at 106, the OSPW may also be ozonated. Ozone is a strong oxidizing species which makes it ideal for the scavenging of solvated electrons and hydrogen radicals. It does this through the aqueous decomposition of ozone, which is triggered by the presence of hydroxide anions (Eriksson, 2005). The OSPW may be ozonated prior to, and/or continuously during, E-beam irradiation. It has been demonstrated that the addition of ozone significantly decreases the power requirements from E-beam irradiation Gehringer at al. (1999). In one possible embodiment, corona discharge from the UV light used for irradiation (or another UV light) could be used as a source of the ozonation.

Together, the E-beam irradiation at 104 and ozonation at 106 provide advanced oxidation reactions so the carbon rings of the NAs can be effectively cleaved, degrading the structure sufficiently for downstream processing.

Alternatively, instead of E-beam irradiation and ozonation, the cyclicity of the soluble NAs in the OSPW may be broken down through gamma irradiation and, optionally, ozonation. In either case, irradiation has the further benefit of eliminating living bio-organisms within the OSPW.

Following irradiation, the NAs dissolved in the irradiated OSPW can be classified into four general categories: (1) saturated fatty acids, (2) unreacted polycyclic naphthenic acids, (3) fatty acids with alcohol and/or aldehyde groups, and (4) mono/di-cyclic naphthenic acids with alcohol and/or aldehyde groups.

At 108, the irradiated OSPW (with the dissolved NAs) are combined with green algae or blue green algae, to form a mixture, to biodegrade the dissolved NAs through heterotrophic metabolism.

Green algae are a large, informal grouping of algae consisting of photosynthetic, eukaryotic organisms. Green algae have chloroplasts that contain chlorophyll, giving them their characteristic bright green color.

Blue green algae are photosynthetic unicellular prokaryotic organisms that live in diverse aquatic habitats ranging from cold salt water to tropical freshwater bodies (Vonshak, 2014). A common misconception is that blue green algae are algae. Despite the given name, they are actually Cyanobacteria. Cyanobacteria is a phylum of bacteria that is one of the oldest photosynthetic organisms on the planet dating back over 3.5 billion years. Algae is theorized to have developed from the symbiosis of a non-photosynthetic eukaryotic cell and cyanobacteria. Though heavily contested, the consensus is that the primary dictating criterion for determining whether an organism is an alga or a cyanobacteria is whether they are prokaryotic or eukaryotic (Knoot, et al., 2018).

In some applications, optionally at 110, the irradiated OSPW may be combined with Spirulina platensis, a Cyanobacteria/blue green algae. Spirulina platensis is naturally found in tropical and subtropical bodies of water with the optimal growing temperature shown to be 30° C. This cyanobacterium is photoautotrophic, meaning it requires a carbon source in addition to carbon dioxide. It has a helical structure and grows to an average length of 60 to 504 μm with a trichome width of 8 to 12 μm and helix diameter of 30 to 70 μm. The method of reproduction for this organism is binary fission. This begins with organisms reaching maturity, at which time, an end will break off and form a new cell (Vonshak, 2014).

In Spirulina platensis specifically, it was found by Tedesco et al. (1989) that the average lipid and fatty acid composition under controlled conditions supporting high growth rates was 7.2% and 2.2%, respectively (Tedesco, et al., 1989). Unlike in eukaryotes, any fatty acids formed will not be stored as primarily triglycerides (Kultschar, et al., 2018).

In other applications, optionally at 112, the irradiated OSPW may be combined with Dunaliella tertiolecta, a green algae. Dunaliella tertiolecta are single-celled, photosynthetic green alga that is adaptable in diverse saline environments.

The mechanisms of biodegradation, carbon nutrient source, ideal growth conditions as well physiology can vary drastically from each species of algae. Naturally, their suitability for biodegradation and subsequent use as biomass for biofuel generation will also vary heavily. Usually based on their characteristics a strain will be suited to one of these two roles more than the other, for example Dunaliella tertiolecta has excellent biodegradation capabilities for hydrocarbons, however, it generates minimal biomass. One way to overcome these shortcomings of any given strain is through cross-culturing. This involves the growth of multiple strains of microorganisms in the same culture. This is not restricted to just multiple strains of algae and could include the use of different fungi like molds or yeasts. In the work completed it was found that using just Spirulina platensis 100% reduction of the target compounds, NAs, was achieved, however, through cross culturing the time required to achieve this could be reduced or greater amounts of biomass could be generated to provide more biomass for downstream energy generation. Thus, in some applications, the irradiated OSPW may be combined with both Dunaliella tertiolecta and Spirulina platensis.

To assist in the biodegradation of the dissolved NAs, and to assist in the biomass generation, light is applied to the mixture at 114, and heat may be optionally applied to the mixture at 118. To that end, various formats for the reactors may be used at 108, 114, and 118, such as race track reactors, tubular reactors, and submerged LED bioreactors. Racetrack reactors are large shallow cannels, with induced media flow. They are often done outdoors on acrid land as the area required is extremely large. Tubular reactors are a more compact design as the tubes can be set-up in multi-layer designs of hundreds of tubes interweaving. Bioreactors typically uses gas sparging to induce flow and has submerged LED light panels that provide a light source. In some simpler arrangements, the lights are only present above the fluid. However, this presents scaling issues as the ratio of light available to media volume decreases. This decrease in light per unit volume of growth media may result in reduced biomass yields (Vonshak, 2014). In the present applications, bioreactors are preferred, as they tend to be more cost effective and compact in design.

At 114, the LED light panels (submerged or positioned above the mixture) may apply light to the mixture. The light may be applied to the mixture at an intensity between 1.5 and 3 W/L. In both cases, at 116, for mixtures containing Spirulina platensis or Dunaliella tertiolecta, applying a light intensity of 3 W/L is preferred. It has been found that application of a higher light intensity helps to maximize the algal biomass production while also minimizing the NA contents in the mixture. Light may be applied to the mixtures in other manners known in the art.

At 118, optionally, heat may also be applied to the mixture. In particular, the mixture may be heated to a temperature between 25 and 35° C. For mixtures containing Spirulina platensis, at 120, the mixture may be heated to a temperature of 32° C. For mixtures containing Dunaliella tertiolecta, at 122, the mixture may be heated to a temperature of 25° C. Heating the mixtures may help to maximize the algal biomass production. Heat may be applied to the mixtures in manners known in the art.

Following the application of heat and light, much of the dissolved NAs have been biodegraded and synthesized for internal use by the Spirulina platensis or the Dunaliella tertiolecta, and further biomass of the green algae/blue green algae have been generated. Thus, at 124, the green algal/blue green algal biomass may be separated from the aqueous phase to be used in the production of biofuels. For example, the green/blue-green algal biomass may be recovered using a vacuum filter through 0.22 μm filter paper.

Embodiments of the present invention are further described with reference to the following study, which is intended to be illustrative and not limiting in nature.

### Example Study

### Materials

All chemicals used in the present work were used as received without further purification. Distilled water used in the lab experiments came from Sigma-Aldrich (EM3234). The material is HPLC grade and contains 50.1 mg/kg of chloride, fluoride, nitrate and sulfate. The F/2 media and artificial seawater were supplied as a premixed solution by the Canadian Phycological Culture Centre out of the University of Waterloo.

The OSPW used in the experiments was provided by InnoTech Alberta. The company and corresponding pond of origin is unknown as this is considered private information that InnoTech Alberta is unable to disclose. All OSPW used in the studies conducted in this study was irradiated prior to use. The OSPW was exposed to 10 kGy of irradiation in a Gamma Cell 220 from an annular Cobalt-60 source. This was conducted in laboratory facility at the department of Chemical Engineering and Applied Chemistry out of the University of Toronto. This cell has a 15 cm diameter with a 20 cm height, with a uniform gamma field spatial distribution resulting in near zero variation in the cell. Dosage was calculated based on the half-life of Co-60. The OSPW is split up into 500 mL batches that are irradiated in groups of threes at a time.

Two different medias were used for the mother cultures and all other growth experiments, F/2 media and Zarrouk media. The F/2 media, recommended and supplied by the Canadian Phycological Culture Centre out of the University of Waterloo, was used for the Dunaliella tertiolecta mother culture and baseline experiments. The media was supplied in sterile 1 L bottles and was stored at 3° C. Transferring of media to glassware for experiments was done strictly in the presence of flame to ensure continued sterile conditions.

The Zarrouk media, selected based on the results shown by El-Monem (2019), was used for the Spirulina platensis mother culture and baseline experiments. The Zarrouk media was prepared in the lab from chemicals procured from Sigma-Aldrich. It was selected based on the recommendation of Pond Technologies Inc. located in Markham, Ontario, who supplied the Spirulina platensis sample used to cultivate the mother culture. All components used have purity of >99%. The formulation was completed in the fumehood with sanitized glassware. The trace amount components: H₃BO₃, MnCl₂·H₂O, ZnSO₄·7H₂O, Na₂MoO₄, and CuSO₄·5H₂O, were initially prepared separately in a 1 L concentrate solution at 100 times the need concentration. 10 mL of the concentrate was then add for every liter of media prepared.

### Methodology: Comparative Study

In this study, 44 experiments were conducted to determine the significant growth factors and their impacts, and the bioremediation and biomass generation potential of two strains of algae, Dunaliella tertiolecta and Spirulina platensis in irradiated OSPW. The results of the comparative study were interpreted using statistical analysis to determine the significant factors and their impacts on growth and biomass generation of the algae. Utilizing the results of the previous experiments, a final 4 L study was conducted using the best performing algae strain under the best conditions found from the previous experiments. The performance of the algae strain was judged based on NA degradation ability and biomass generated.

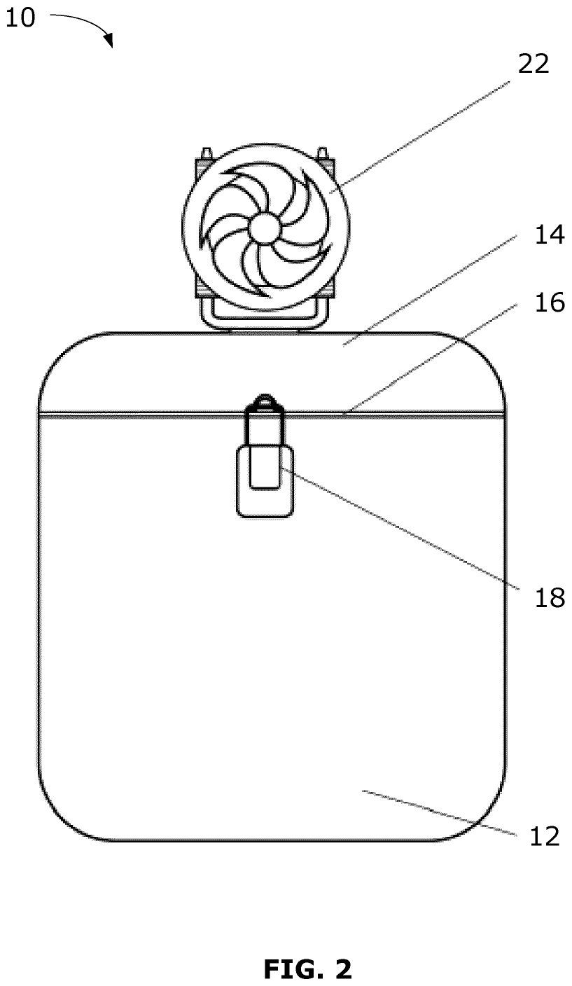

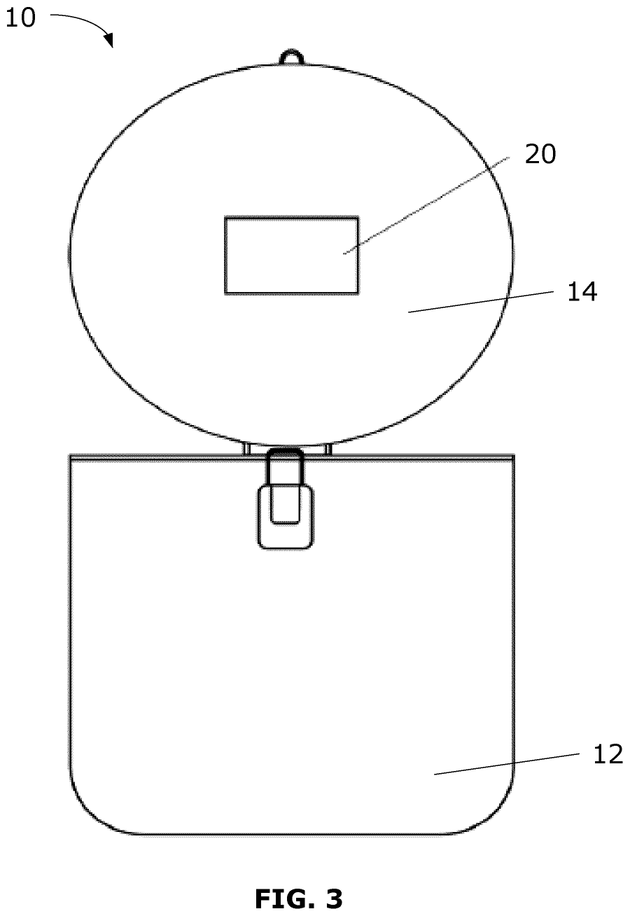

FIGS. 2 and 3 illustrate an example reactor set up 10 used in the comparative study. The experiments in the comparative study were performed in 250 ml Erlenmeyer flasks, with 100 ml of total media inside. To provide the correct light intensity, two to three of the flasks were placed in an airtight 3 L 301 stainless steel bucket 12, with an acrylic lid 14 that feature a silicone sealing gasket 16 and a leveler locking latch 18. The light source is/was a 50 watt coated array, 640 nm: 680 nm (1:1 bulb ratio) LED light panel 20 that has been mounted to a cut out in the top of the acrylic lid 14. A Deep Cool GAMMAX 200T heat sink 22 has been mounted to the back of the LED 20 in order to prevent the heat from operation of the LED from interfering with the experiments. A Sky Top Power STP3005D was connected to the heat sink 22 and the LED light panel 20 to precisely tune the power being provided. To maintain the elevated temperatures in the study, the reactor setups 10 were placed in two different incubators, a Thermo Scientific Symphony 5.3 and a Shell Lab Model 1540. For samples that could be run at the ambient temperature in the lab, 25° C., the reactor setups 10 were placed in the fumehood. FIG. 2 is a closed view of the reactor set up 10, and FIG. 3 is a view of the reactor set up 10 with the lid 14 open and with the LED light panel 20 visible.

The operating conditions for the comparative study experiments were conducted at the following levels: temperatures of 25, 28.5 or 32° C. and light intensities of 1.65, 2.35 and 3 W/L. The operating conditions used in the experiments were decided based on two primary influences, the first being the ideal conditions from literature and the second being restrictions to ranges that could be applied to large scale industrial operations. The bioreactors that have been sourced for the planned pilot plant are created by Pond Technologies and these systems are capable of light intensities of up to 3 W/L in large scale operations. As can be seen in their literature, they claim 10× the growth rate of other alternative formats for growing algae (Pond, 2020). The temperature range was dictated by literature with Dunaliella tertiolecta expected to prefer the lower end of the range, while Spirulina platensis is expected to grow best at the higher end of the range.

In the comparative study, a full two-factorial experimental design was utilized. The design featured a block on the strains, which split the 44 experiments into two sets of 22 experiments. The first set were experiments being conducted with Dunaliella tertiolecta in eleven, sterilized, Erlenmeyer flasks filled with 100 mL of prepared F/2 media. The other eleven were filled with 100 mL of irradiated OSPW. All transfers of media to glassware were done in the presence of flame under the fumehood. Once the growth media was in all twenty-two flasks, 20 mL of the Dunaliella tertiolecta mother culture was added to each of the flasks respectively. The growth solution was then gently agitated by hand, before being placed in a preselected bioreactor with each reactor standardly having three flasks placed inside. Two reactors only had two flasks. The light intensities of these reactors were adjusted to account for this. The reactors were set to three different light intensities and placed in three different temperature environments. The light intensities were as follows 1.5 W/L, 2.25 W/L and 3 W/L. The temperatures the experiments were carried out at were 25° C., 28.5° C., and 32° C.

The second set of experiments were conducted in a similar manner with Spirulina platensis in eleven, sterilized, Erlenmeyer flasks filled with 100 mL of prepared Zorrouk media. Appendix A, Tables A1 and A2 set out the experimental conditions for each of the experiments run during the comparative study and the legend for interpreting the codified factor levels.

There are 44 experiments contained in this study, in each of those experiments the cell counts were taken every 24 hours. Based on the cell counts, the cell mass and the NA content of the top eight performing experiments, conducted in OSPW media, were measured. All cell counts were performed using a hemocytometer (LW Scientific CTL-HEMM-GLDR Hemocytometer). Results for initial counts were recorded under 0 hrs of growth. Cell counts were conducted every 24 hrs of growth time for the eighteen flasks over seven days. After day 7, all generated algal biomass was recovered using a vacuum filter through 0.22 μm filter paper. The filter papers were weighed before and after the paper had dried to determine the dry cell mass on a per liter basis. The filtered material was collected and then used for HPLC testing in order to establish the presence and concentration or lack thereof of NAs.

### Methodology: Large-Scale Study

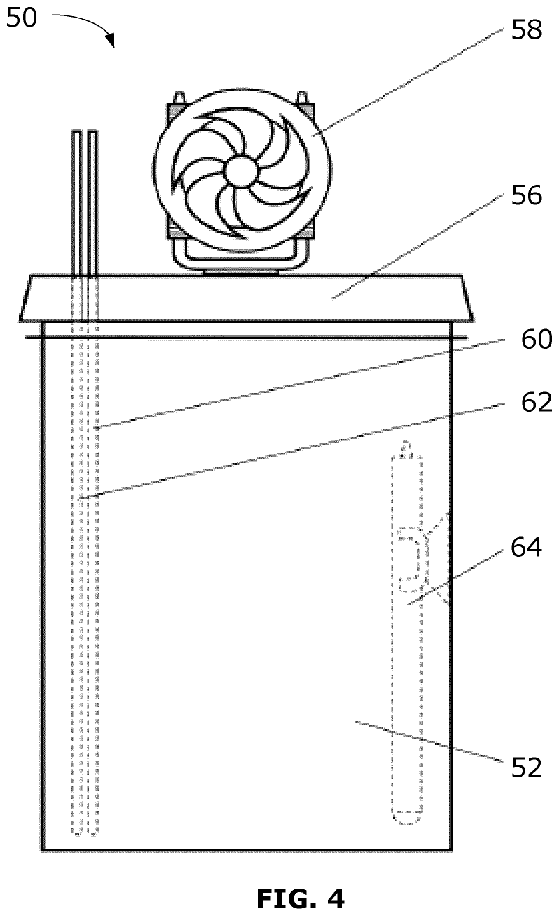

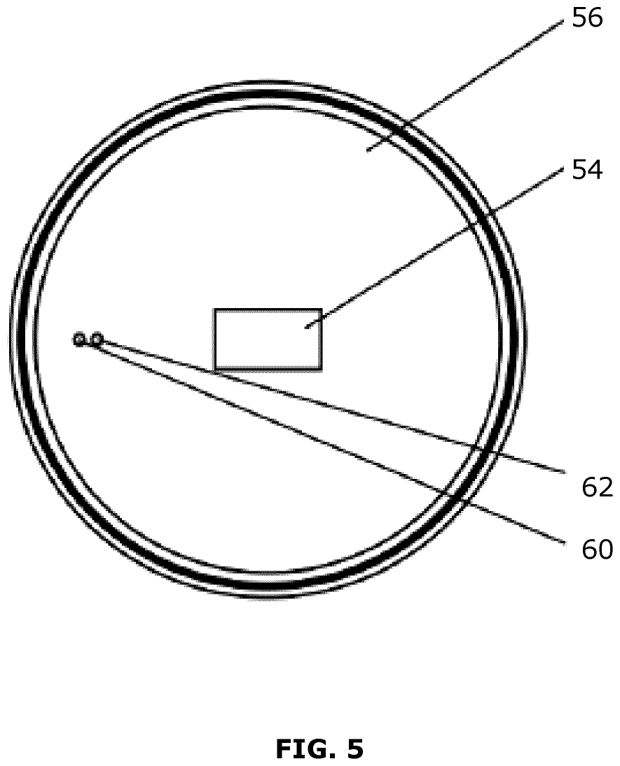

FIGS. 4 and 5 illustrate an example reactor set up 50 used in a large-scale study. The large-scale study was conducted in a 5-gallon bucket (with 4 Liters media volume) reactor 52 with optimum conditions obtained from the comparative study above. Initially, 3.9 L of irradiated OSPW were added to the reactor 50, where a 100 ml inoculation volume was then added. Light source featured a 50 watt coated array, 640 nm: 680 nm (1:1 bulb ratio) LED light panel 54 that is mounted to a cut out in the bucket lid 56. To dissipate heat from operation a Deep Cool GAMMAX 200T heat sink 58 is mounted to the back of the LED light panel 54 in order to prevent the heat caused by the operation of the LED light panel 54 from interfering with the experiments. An air feedline 60 and a CO₂ feed line 62 run into the reactor 50, through the lid 56, to sparge gas that provides constant gentle agitation to the algae in the reactor 50. A 50 W Eheim Jager TruTemp Aquarium Heater 64 was used to regulate the temperature in the reactor 50. This device has an accuracy of f 0.5° C., with a temperature range of 18 to 34° C., that features a laboratory grade glass shell that prevents contamination of the media while also preventing corrosion of the device. A Sky Top Power STP3005D was connected to the heat sink 58 and the LED light panel 54 to precisely tune the power being provided. FIG. 4 is a closed view of the reactor set up 50, and FIG. 3 is a bottom view of the bucket lid 56 with the LED light panel 54 visible.

For the large-scale study, the temperature was set at 32° C., while the light intensity was set to 3 W/L. Furthermore, the experiment was conducted under conditions of a large-scale Pond Technologies Reactor (1000 Liters). A constant air feed of 0.5 L/min was provided to the solution to gently agitate the culture. The sparging of the gas had a secondary function as well, the gas bubbles being passed through the solution served to increase the surface area for the mass transfer of CO₂ to the solution, leading to better CO₂ uptake, which has been shown to promote better rates of photosynthesis (Loomba et al. 2018).

After inoculation, an initial cell count was performed using a hemocytometer and results of this count were recorded as 0 hrs of growth. Each subsequent 24 hrs over the following 32 days, another cell count was performed on the culture. Every day of the study after the cell count, 10 ml of the culture was passed using a vacuum filter through a 0.22 μm filter paper. The filter papers were weighed before and after the paper had dried, to determine the dry cell mass on a per liter basis. The media, after recovering the algal biomass, was collected and analyzed by ultra high-performance liquid chromatography (UHPLC) testing in order to quantify the NA contents.

### Results and Discussion: Comparative Study

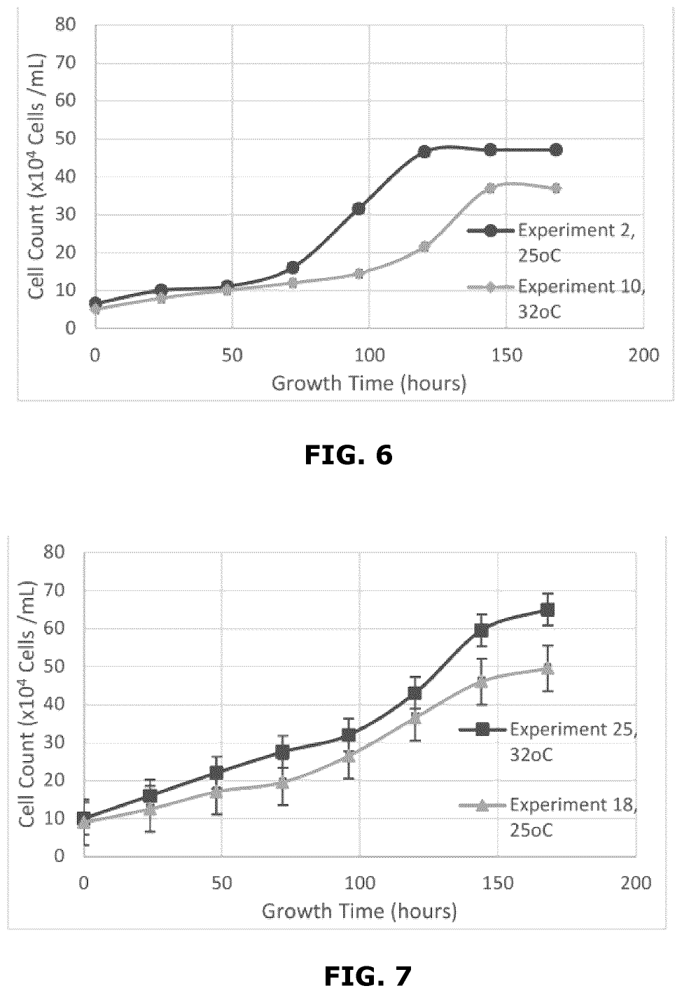

FIGS. 6-9 show the growth results from the comparative study for the experimental runs in F/2 media using Dunaliella tertiolecta. During the study, the experiments were conducted at different temperatures, light intensities, using different strains of algae and in different medias. In FIG. 6, the cell counts over the 168 hr fermentation period were recorded for experiments conducted at 1.65 W/L light intensity, at various temperatures. FIG. 7 is similar, but the experiments depicted in this figure were conducted at 3 W/L. The general trend observed when comparing these two figures is that Dunaliella tertiolecta grown in F/2 media prefers higher light intensity. This is demonstrated by the final cell counts for both experiments in FIG. 7 being higher than those in FIG. 6.

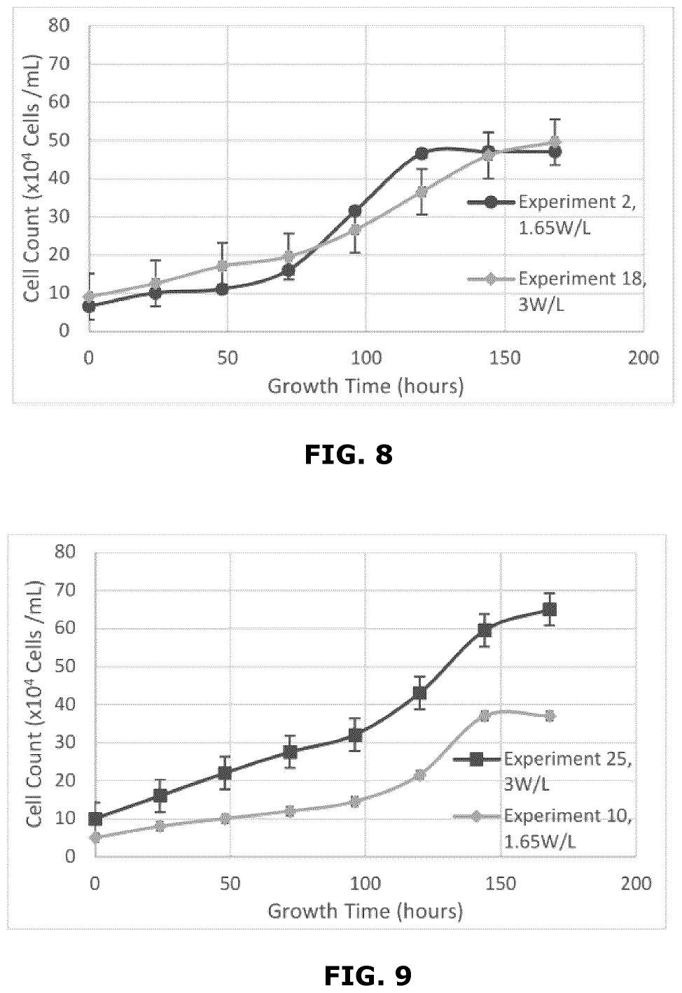

FIG. 8 shows the cell count results for the experiments conducted at 25° C., at various light intensities. FIG. 9 presents the results for experiments carried out at 32° C. and various light intensities. When comparing the results between the figures, it is noticeable that the elevated temperature is beneficial when coupled with the higher light intensity, otherwise the lower temperature growth conditions are superior. Additionally, the light intensity had a negligible effect on the final cell counts when the cultures were grown at 25° C.

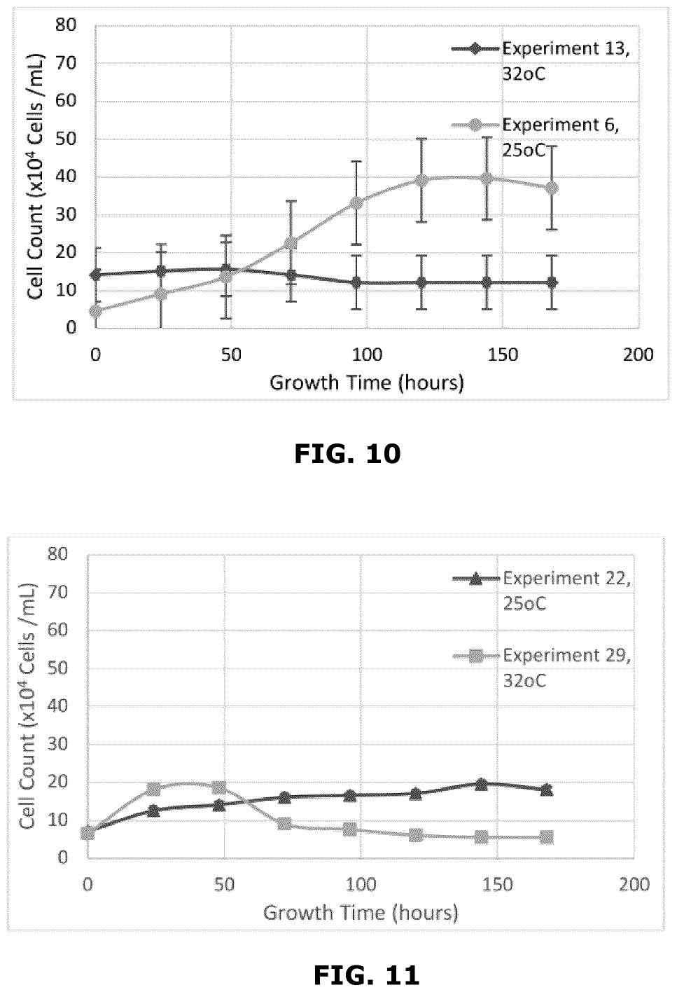

FIGS. 10-13 show the growth results from the comparative study for the experimental runs in irradiated OSPW media using Dunaliella tertiolecta. Similar to the experiments using F/2 media, the experiments were run at different temperatures, light intensities and in different medias. FIG. 10 contains the cell count data over the fermentation period for experimental runs at 1.65 W/L light intensity, at various temperatures. FIG. 11 is similar, but the experiments depicted in this figure are conducted at 3 W/L. The trend observed between these two figures is that Dunaliella tertiolecta grown in irradiated OSPW media prefers lower light intensity. However, the light intensity does not appear to be the most significant factor, as temperature is more strongly influencing the results.

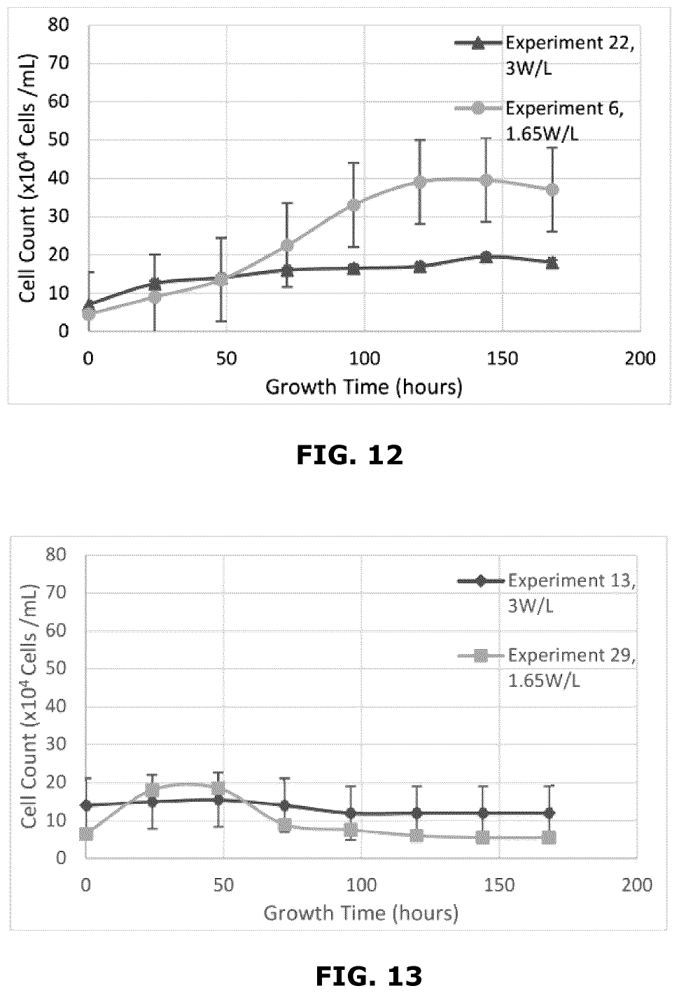

FIG. 12 shows the cell count results for the experiments conducted at 25° C., at various light intensities. FIG. 13 presents the results for experiments at 32° C. and various light intensities. When comparing the results between the figures, it is apparent that lower temperatures are superior. This is demonstrated by both experiments in FIG. 12 outperforming those in FIG. 13 regardless of the light intensity.

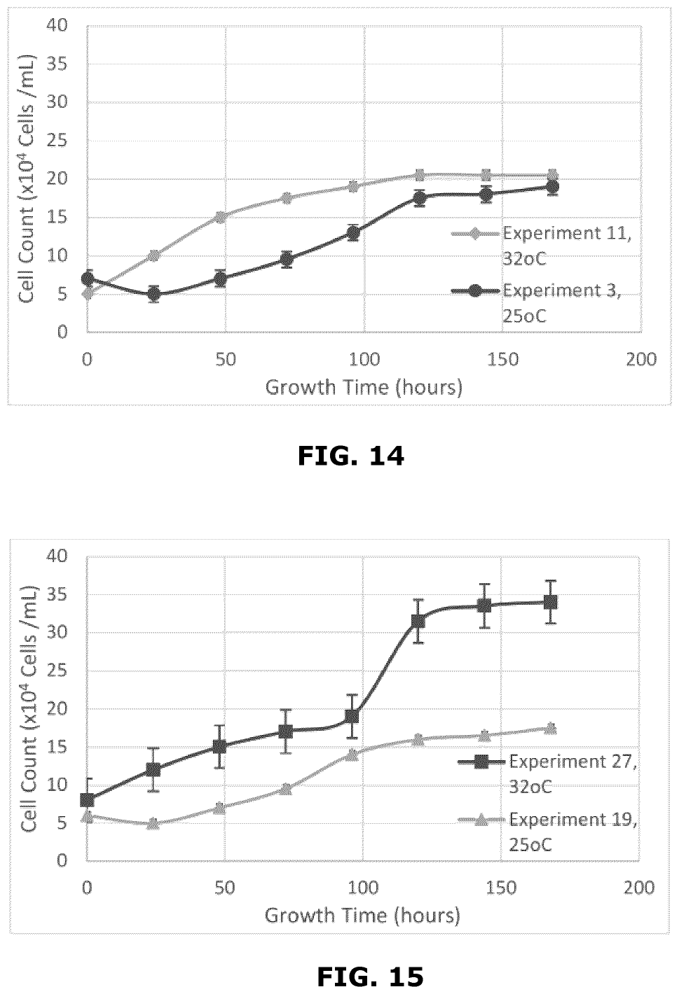

FIGS. 14-17 show the growth results from the comparative study for the experimental runs in Zorrouk media using Spirulina platensis. Similar to the experiments using F/2 media, the experiments were run at different temperatures, light intensities and in different medias. FIG. 14 depicts the cell count data over the fermentation period, for the experiments conducted at 1.65 W/L light intensity, at various temperatures. FIG. 15 is similar, but the experiments shown in this figure are conducted at 3 W/L. The trend observed between these two figures is that Spirulina platensis grown in Zorrouk media prefers higher light intensity. However, the light intensity does not appear to be the only influencing factor and temperature is also impacting the results. This can be seen by the highest cell count belonging to FIG. 15, while the second highest, despite being significantly lower, is contained in FIG. 14.

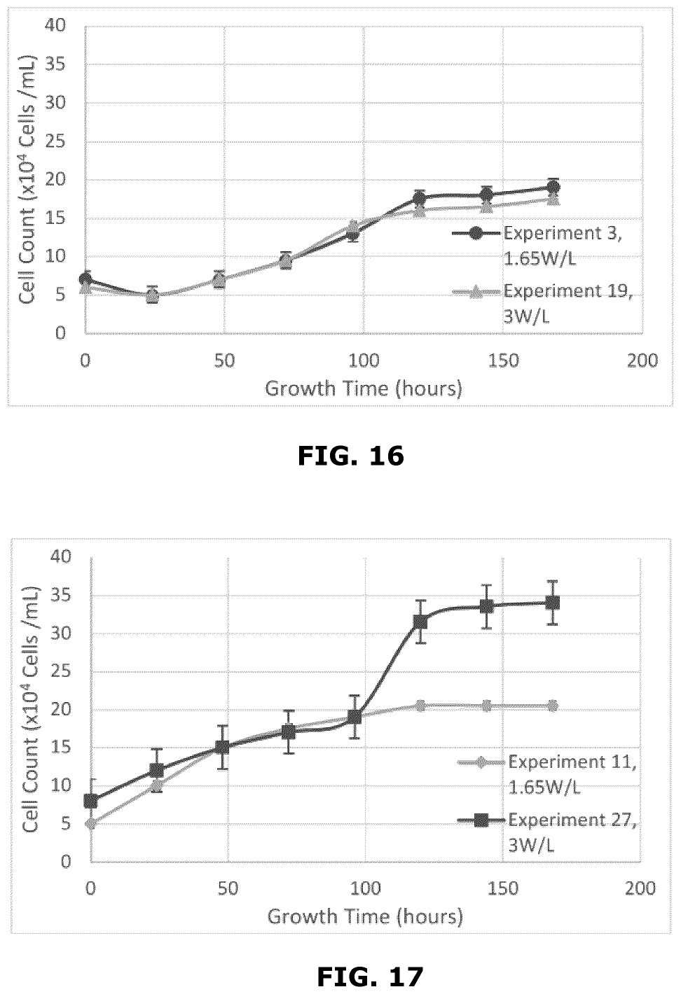

FIG. 16 shows the cell count results for the experiments conducted at 25° C., at various light intensities. FIG. 17 presents the results for experiments at carried out at 32° C. and various light intensities. When comparing the results between theses two figures, it is apparent that higher temperatures are superior. This is demonstrated by both experiments in FIG. 17 outperforming those in FIG. 16, regardless of the light intensity.

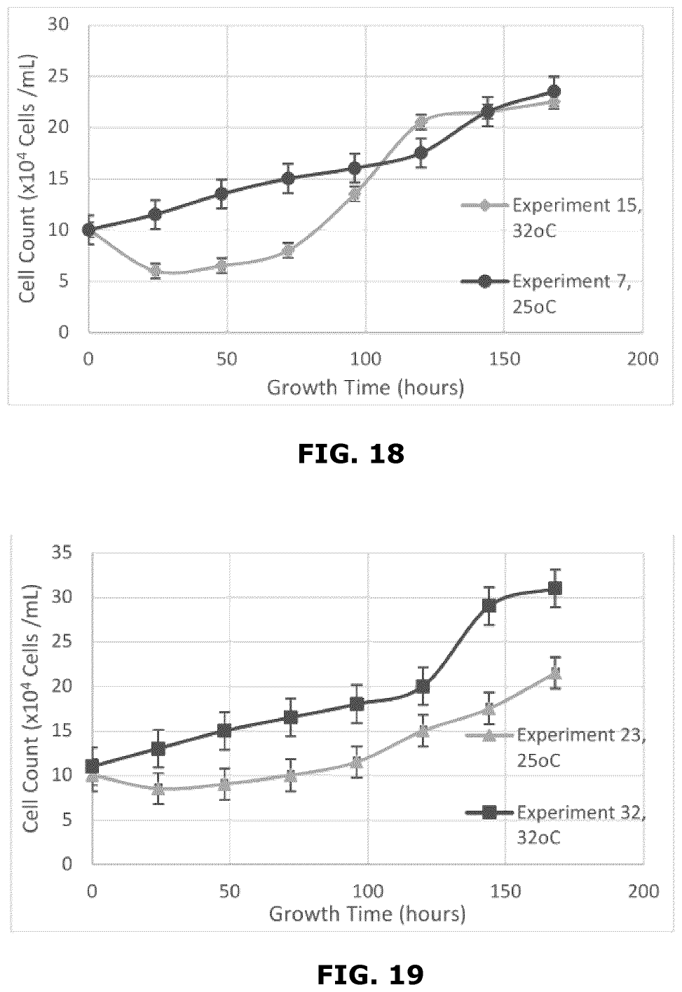

FIGS. 18-21 show the growth results from the comparative study for the experimental runs in irradiated OSPW media using Spirulina platensis. Similar to the experiments using F/2 media, the experiments were run at different temperatures, light intensities, using different strains of algae and in different medias. In FIG. 18, the cell count data over the fermentation period is recorded for experiments run at 1.65 W/L light intensity, at various temperatures. FIG. 19 is similar, but the experiments depicted in this figure are conducted at 3 W/L. The trend observed between these two figures is that Spirulina platensis grown in irradiated OSPW media prefers higher light intensity. However, the light intensity does not appear to be the only influencing factor. This can be seen by the highest cell count being contained in FIG. 19, while the second highest, despite being significantly lower, is contained in FIG. 18.

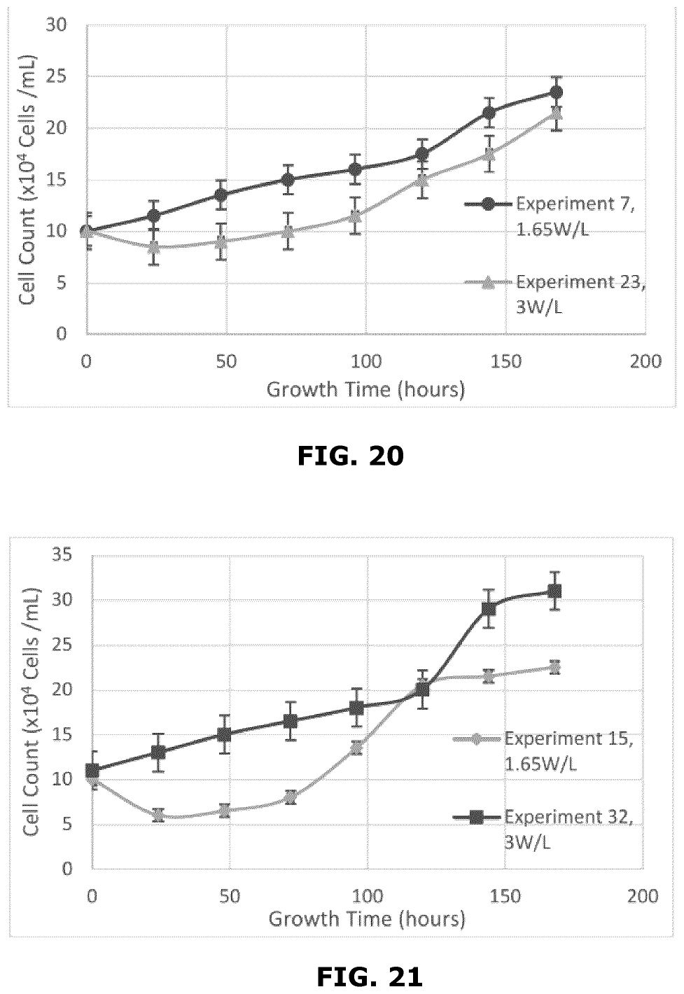

FIG. 20 shows the cell count results for the experiments conducted at 25° C., at various light intensities. FIG. 21 presents the results for experiments at 32° C. and various light intensities. When comparing the results between these two figures, it is apparent that higher temperatures are superior. This trend is not as pronounced as it is in experiments conducted in the previous medias. This is demonstrated by the relatively close final cell counts of all experiments, aside from the best performing experiment, which performed significantly better and was conducted at the higher temperature.

All experiments were analyzed for algae growth (see Appendix A, Table A3 for cell counts). However, only the top from four from each strain (Experiments 5, 6, 7, 8, 21, 22, 31 and 32) were analyzed for NA reduction and biomass generated. One sample of untreated OSPW and one of irradiated OSPW were also analyzed for comparison. Table 1 (below) shows results for the dry weight of algae that was generated in the top 8 highest cell count experiments from the comparative study, together with the percentage reduction in the NA concentration. See Table A2 in Appendix A for the experiments' conditions.

TABLE 1

| Experiment # | | Dry Weight of | Reduction In |
|---|---|---|---|
| or Sample | | Algae Biomass | Naphthenic |
| Name | Algae Strain | Harvested (g/L) | Acids |
| Experiment 5 | Dunaliella tertiolecta | 0.102 | 30.5% |
| Experiment 6 | Dunaliella tertiolecta | 0.114 | 54.6% |
| Experiment 7 | Spirulina platensis | 0.523 | 65.7% |
| Experiment 8 | Spirulina platensis | 0.509 | 64.1% |
| Experiment 21 | Dunaliella tertiolecta | 0.084 | 81.5% |
| Experiment 22 | Dunaliella tertiolecta | 0.093 | 95.7% |
| Experiment 31 | Spirulina platensis | 0.436 | 72.3% |
| Experiment 32 | Spirulina platensis | 0.635 | 68.6% |

Table 1 reveals that the NA concentrations in all of these 8 experiments were reduced compared to the raw OSPW, while algae cell growth was also observed in all experiments. Apart from experiment 5, there is over a 50% reduction from the concentration found in the OSPW sample. Both experiments 5 and 6 were conducted at the lowest light intensity, 1.65 W/L, and temperature, 25° C., levels. The maximum reduction in NAs was observed in experiment 22, with 95.7% reduction. Maximum cell growth, based on dry weight, was observed with experiment 32, with a yield of 0.635 g/L. However, experiment 32 yielded a lower NA reduction, with 68.6% reduction. The lowest cell growth of 0.084 g/L was observed in experiment 21. Experiments 32 was carried out at 32° C. with a light intensity of 3 W/L, while experiments 21 and 22 were both carried out at 25° C. and 3 W/L.

The next trend observed is that, regardless of the algae strain, the experiments grown at the highest light intensity level achieved the highest degree of NA degradation. A likely explanation for this trend stems from both algae species being photoautotrophic, which means that they metabolise carbon-based compounds for their carbon source and use light energy from photosynthesis to create energy carriers such NADPH and ATP, which coupled with carbon dioxide feed the Calvin cycle (Kultschar and Llewellyn, 2018). This signifies that an increase in photosynthesis caused by an increase in available light energy, would result in an increased uptake of carbon metabolites to match. The carbon metabolites in this case being the NAs.

Another general trend is that, regardless of strain or media, the higher level of light intensity, 3 W/L, yielded better cell growth, indicated by steeper curves from the cell count results. When comparing the cell count curves in FIGS. 7, 11, 15, and 19, all of them exhibit more rapid cell growth in exponential growth phase of the experiments, when compared to the cell growth curves in FIGS. 6, 10, 14, and 18. The reason this trend is not noticeable in the beginning of the experiments (except for Spirulina platensis experiments using Zorrouk media) is that photoinhibition affects the growth rate of the cultures.

Another key metric when deciding which algae strain to use in the large-scale replicate study, was the amount of biomass generated. This is important, as at an industry scale, the biomass generated in the bioreactors can be utilized to produce biocrude that can potentially provide power for the process. This means that the biomass generated should be maximized to ensure the most energy can be generated. The units used to measure biomass generated was dry cell weight/L.

It was determined, based off the results of the comparative growth study experiments, that at elevated light intensity levels Dunaliella tertiolecta is superior at degrading NAs, with the standards showing NA reductions of 95.7% and 81.5%. In comparison, the Spirulina platensis experiments boasted lower NA degradation at 72.3% and 64.1%. Despite the inferior results however, the Spirulina platensis was still able prove that it is capable of to degrading NAs. This would imply that if the algae had a longer period to degrade the NAs, then despite Spirulina platensis lower degradation rate, it would be able to sufficiently remove the NAs in the OSPW. This is important because Spirulina platensis yields significantly more biomass than the Dunaliella tertiolecta, as can be seen in Table 1. The experiment with the highest degradation of the NAs using Spirulina platensis, experiment 31, yielded 0.436 g cell dry weight/L. In comparison, experiment 22 the top experiment for degradation of NAs with Dunaliella tertiolecta, yielded only 0.093 g cell dry weight/L.

### Statistical Analysis of Comparative Growth Study Results for Biomass Generation

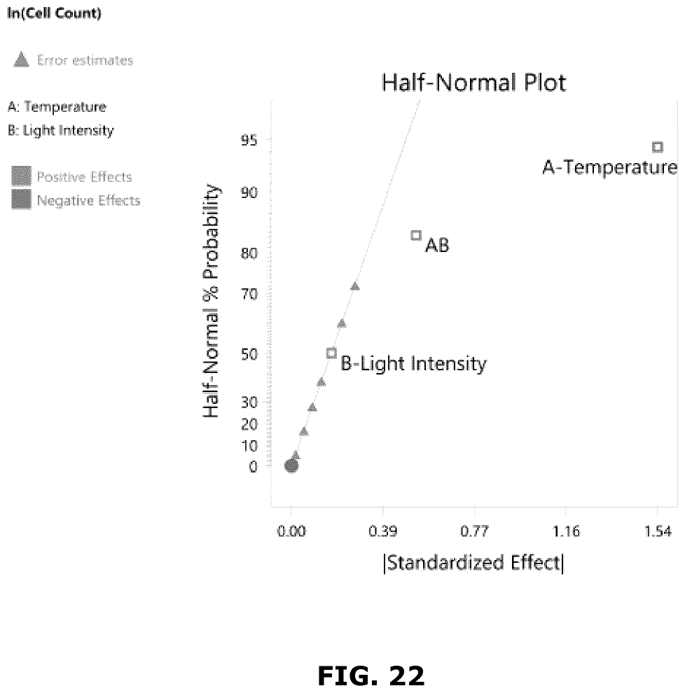

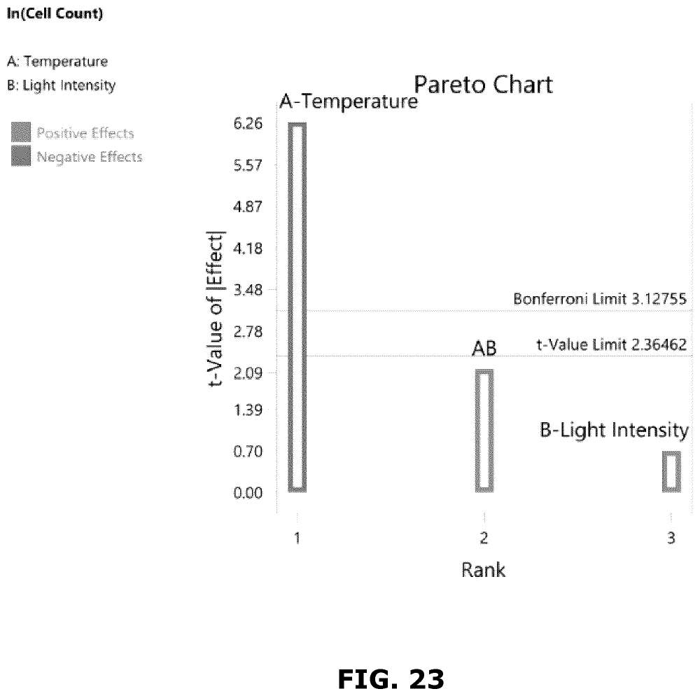

The results of the Dunaliella tertiolecta experiments conducted using irradiated OSPW media are shown in FIGS. 10 to 13. It can be seen that the variance is significantly lower with the experiments separated by media. The benefits of this are noticeable in the results of the pareto chart and half-normal plot, FIGS. 22 and 23. These figures demonstrate with a high degree of certainty that the main driving force behind the growth of the culture is the temperature (effect A). This is further supported by the ANOVA conducted, which determined that the p-value of effect A is 0.0003. This means that there is 0.03% chance that the effect of the temperature was caused by random chance. In contrast the light intensity (B) and interaction effect (AB), did not exceed the t-value limit and had p-values of 0.4837 and 0.0550, meaning there is 48.37% chance that the effect attributed to light intensity and a 5.5% chance that the effect from the interaction of the light intensity and temperature are just the result of random chance. When operating at 95% confidence, only effects with a p-value less than 0.05 are considered significant, for this reason based on the ANOVA effect B and AB are considered insignificant, while A is significant. The proximity to acceptance region for effect AB, however, means that it should not outright be dismissed; if the confidence being considered was 90% instead of 95% then it would be considered significant. The fact that light intensity was deemed insignificant does not mean it has no effect either, but that the effect is hard to establish because of the more dramatic results caused predominantly by temperature and to a much lower degree the interaction between light intensity and temperature.

Upon observing the codified regression model, Equation I (below), an increase in the cell count can attributed to a decrease in temperature, an increase in light intensity and increased interaction between temperature and light intensity.

$$ln ( Cell Count ) = 11. 47 - 0.7709 * {x}_{A} - 0.0843 * {x}_{B} + 0.2623 * {x}_{A} * {x}_{B} \qquad Equation I$$

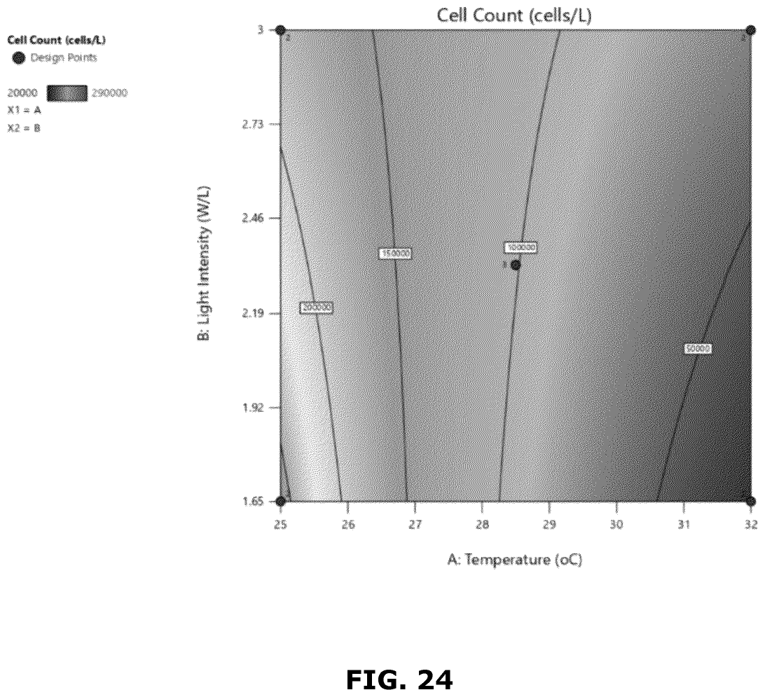

This is further supported by the contour chart, FIG. 24, which shows that optimal growth is expected to be achieved at the lowest levels of both temperature and light intensity. The codified equation is further utilized to compare the general impact of the coefficients with each other. Factors B and AB are positive terms, this indicates that an increase in ether light intensity or the interaction between light intensity and temperature, or a decrease in temperature (as it is a negative term) will lead to an increase in the cell count. It can also be seen that temperature has a more significant impact than the other two factors, with a coefficient of 0.7709. The interaction between temperature and light intensity, with a coefficient of 0.2623, also has considerable significance when compared with light intensity, which has over three times less impact at a coefficient value of 0.0843. The limitation of the coded equation is that it is only applicable when estimating cell counts at the given levels of the factors. Due to this limitation, when predicting cell counts with factor values outside of the levels, Equation II (below) can be used. The coefficients in this equation have been scaled based on the units of each factor, therefore it is no longer possible to compare.

$$ln ( Cell Count ) = 24. 81538 - 0.478361 * {x}_{Temperature} - 3.03883 * {x}_{Light Intensity} + 0.111008 * {x}_{Temperature} * {x}_{Light Intensity} \qquad Equation II$$

The results from the model were in alignment with Dunaliella tertiolecta growth. Dunaliella tertiolecta grows optimally at temperatures around 25° C. (Seepratoomrosh et al. 2015). This means that warmer growing conditions are not typically conducive to maximum growth. With the stress the experiments were facing from non-ideal growth media, irradiated OSPW, it is anticipated the addition of no-ideal high temperature growth conditions would serve to exacerbate the retarding affects on the growth rates. It should be noted that the effects from the new media, seem to be amplifying the negative effects of high temperature growth inhibition, until they became the dominant effect.

Despite not being considered significant, light intensity does have a positive coefficient in the regression model. The effects of photoinhibition are still suspected to be playing a role in the outcome of the experiments, even though the effect term being considered is positive. Evidence for the theory can be seen in the poorer performance of the experiments at the highest light intensity and lowest temperature levels, experiments 21 and 22, which ended the study with 170,000 cells/mL and 180,000 cells/mL. This compared with experiments 5 and 6, conducted at the lowest level of temperature and light intensity, which produced the best yields at 215,000 cells/mL and 370,000 cells/mL. It is still expected, that over a longer study the higher light intensity would likely yield better results, as the alga would have time to acclimate and out perform the experiments being run at lower light intensity.

Due to the stress the experiments conducted at the high temperature factor level were experiencing from the media and non-ideal temperature, it would be assumed that the addition of the high light intensity would serve to increase inhibiting affects on the growth rates. Therefore, it was unexpected that the interaction effect between temperature and light intensity would be positive. As shown in FIG. 11 and Table A2, experiments 29 and 30 had some of the lowest cell counts, at 55,000 cells/mL and 50,000 cells/mL respectively. Both of these experiments were at the highest light intensity and temperature levels. By examining FIG. 13 it can also be noted that experiment 29 is trending downwards, this leads to the conclusion that there a significant likelihood that if given a longer experimental period the interaction effect term would become negative. It is only positive currently, because the experiment was not long enough for the trend to fully mature.

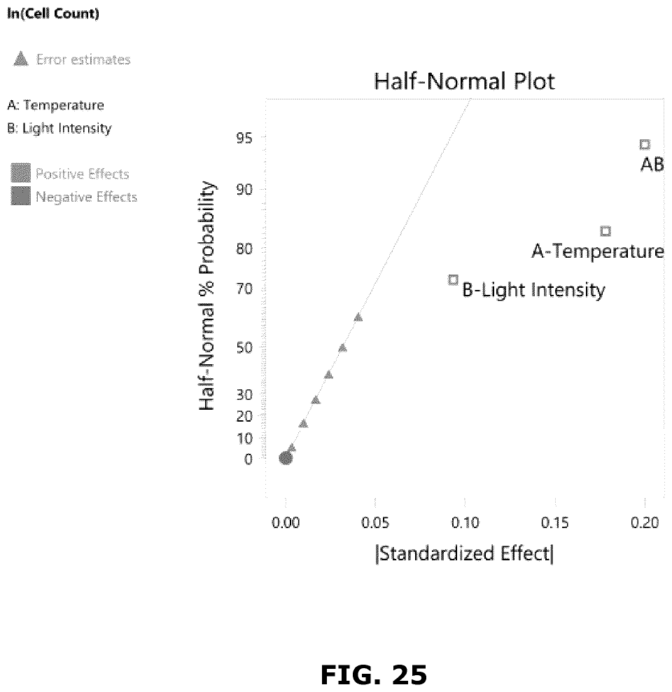

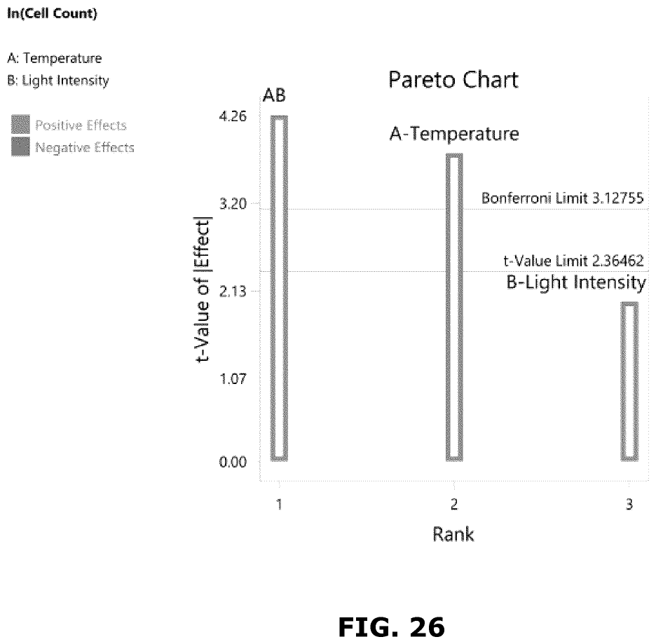

The results from the Spirulina platensis experiments conducted using irradiated OSPW media are shown in FIGS. 18 to 21. Upon examination of the pareto chart and half-normal plot, FIGS. 25 and 26 there is a high degree of certainty that the main driving forces behind the growth of the culture is the temperature (effect A) and the interaction between temperature and light intensity (effect AB). Conversely, light intensity (effect B) was found to be insignificant as the t-value for the effect was lower than the t-value limit. This is further supported by the ANOVA conducted, which determined that the p-value of effect A is 0.0046, AB is 0.0025 and B is 0.0687. This means that there is 0.46%, 0.25% and 6.87% chance that the effects of the temperature, interaction between temperature and light intensity and light intensity were caused by random chance. With a 95% confidence, only effects with a p-value less than 0.05 are considered significant. For this reason, based on the ANOVA, effects A, AB are considered significant while effect B is considered insignificant. The fact that effect B is still below 0.1 however, means that it should not be dismissed; if the confidence being considered was 90% instead of 95% then it would be considered significant.

Upon observing the codified regression model, Equation III (below), an increase in the cell count can be attributed to an increase in temperature, an increase in light intensity and increased interaction between temperature and light intensity.

$$ln ( Cell Count ) = 12. 36 + 0.0888 * {x}_{A} + 0.0465 * {x}_{B} + 0.0996 * {x}_{A} * {x}_{B} \qquad Equation III$$

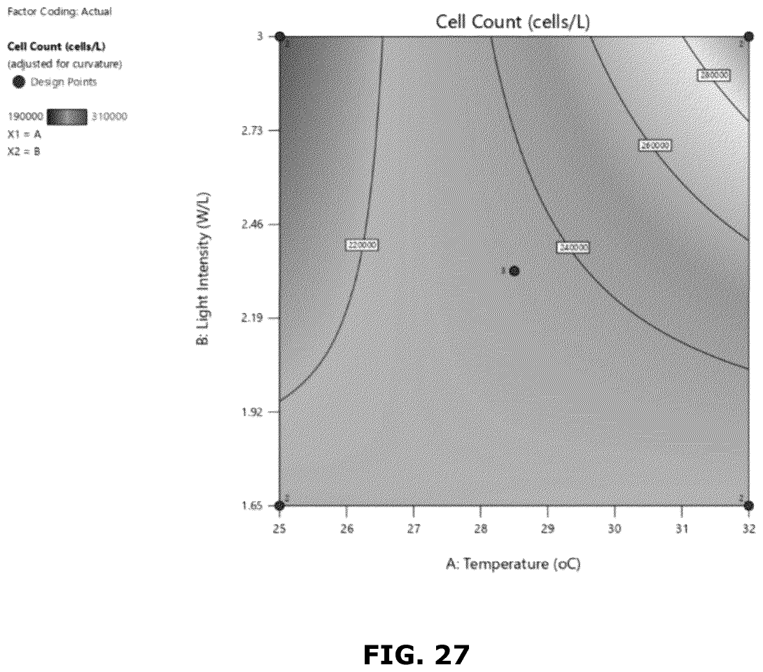

This is further supported by the contour chart, FIG. 27, which shows that optimal growth is expected to be achieved at the highest levels of both temperature and light intensity. The codified equation is further utilized to access and compare the general impact of the coefficients with each other. All three factors are positive terms indicating that an increase in any of them will lead to an increase in the cell count. It can be seen that temperature, with a coefficient of 0.0888, has a similar impact to the interaction factor term, which has a coefficient of 0.0996. Both factors, have a significantly larger impact than the light intensity effect coefficient which is at 0.0465. The limitation of the coded equation is that it can only be used to estimate the cell count for the given levels of the factors. Due to this limitation when predicting cell counts with factor values outside of the levels, Equation IV (below) can be used. The coefficients in this equation have been scaled based on the units of each factor, therefore it is no longer possible to compare.

$$ln ( Cell Count ) = 14. 27039 - 0.072702 * {x}_{Temperature} - 1.13320 * {x}_{Light Intensity} + 0.042179 * {x}_{Temperature} * {x}_{Ligh Intensity} \qquad Equation IV$$

The results from the model were in alignment with Spirulina platensis growth. Spirulina platensis optimally grows at temperatures around 32° C. (Vonshak, 2014). This means that warmer growing conditions are typically conducive to maximum growth. It was therefore expected that the temperature affect term in the equation would be positive. It can be observed in FIG. 21 and Table A2 that every experiment conducted at the highest temperature level performed well, with both of the highest yielding experiments, 31 and 32, among them. It is suspected that stress introduced from utilising the non-ideal media, causes the dominant effect to become the interaction between temperature and light intensity.

Another deviation in these experiments was that the light intensity effect is not significant. Despite this, light intensity has a positive coefficient in the regression model; this is the same for all the models for the experiments in this study. The results indicate the influence of photoinhibition. From the results, it seems to be more prevalent in the poorer performing experiments. FIG. 20 and Table A2 provide good evidence for this. When comparing experiments 23 and 24, to experiments 7 and 8, the only difference in the growth conditions for were the light intensity levels. With 23 and 24 being grown at the highest intensity and experiments 7 and 8, at the lowest. One possible reason as to why the influence of photoinhibition may have become noticeable again, is that the stress from the non-ideal media coupled with the growth inhibition from temperature, made it more difficult to for the alga to adapt as readily to the higher light intensity. It is still expected that over a longer study the higher light intensity would yield better results.

Given that the light intensity effect is positive (ignoring the short-term stress caused by photoinhibition) coupled with Spirulina platensis' preference towards higher temperature growth conditions, it was expected that the interaction effect between temperature and light intensity would be positive. The effect of the interaction term seems to be prominent regardless of a culture's performance. This is demonstrated in FIG. 21 and Table A2 where experiments 31 and 32 outperformed experiments 15 and 16 and FIG. 20, where experiment 7 outperformed experiment 23.

### Results and Discussion: Large-Scale Study

As shown in the results from the reduction of the NAs and the biomass generated, it was decided that for the large-scale replicate study experiment that Spirulina platensis would be used. Both strains proved effective at degrading the NAs in the irradiated OSPW, however, the lack of biomass generated by the Dunaliella tertiolecta, when compared with Spirulina platensis, would prove less effective, as the biomass has potential use as a fuel source. Once the strain was selected, the growth conditions for the large-scale replicate study were selected to be light intensity at 3 W/L and temperature of 32° C. These conditions were chosen based on the optimization contour chart, FIG. 27, which estimates the best growth to occur at the highest levels of light intensity and temperature. This is further supported by the regression model, as the interaction factor between light intensity and temperature was found to be the most significant term for Spirulina platensis grown in irradiated OSPW. Finally, this is also beneficial from a biodegradation standpoint as it was found that higher light intensity yields better degradation of NAs.

The primary objective in the large-scale replicate study was to establish the viability of the most promising experiment, under scaled up and industrial reactor growth conditions. The experiment was also run for a longer period (32 days), with the effect on the NA concentration documented.

In the comparative study the largest NA reduction, for an experiment with Spirulina platensis, was 72.3%, after 7 days. It was theorized that given more time the reduction would be significantly higher. Therefore, as expected, after 32 days, there was a complete (100%) elimination of the NAs. This confirmed the ability of the Spirulina platensis at higher volumes, under simulated industry growth conditions (which included the use of gas sparging for agitation and CO₂ feed), to effectively degrade the NAs in irradiated OSPW.

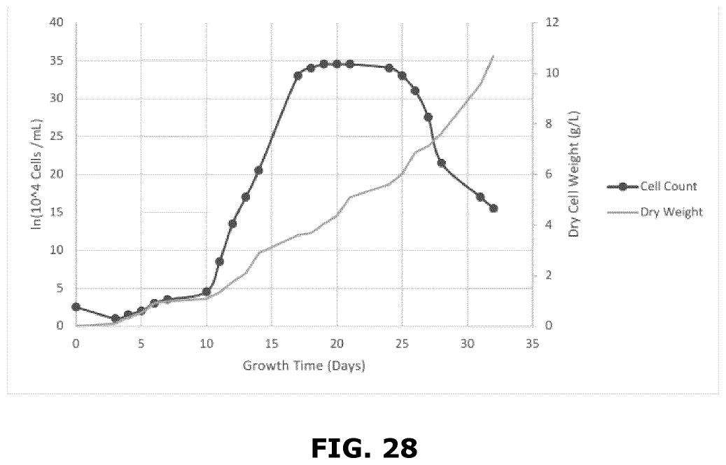

As can be noted in FIG. 28 in this experiment, the culture did not reach its exponential growth phase until day 10. This presents an opportunity for improvement as it has been established that the degradation of NAs is connected to the generation of energy in the algae. This implies that, during periods of increased energy demand (like the exponential phase), the most degradation would occur. It would therefore follow that maintaining the culture in the exponential growth phase would be ideal. This can be achieved with the use of the continuous feed bioreactors that have been identified for this process for pilot and industry scale.

In the comparative study, the highest amount of biomass generated when using Spirulina platensis was 0.635 g dry cell weight/L. This was after 7 days of growth. In comparison, in the large-scale replicate study, the culture grew quicker, yielding 0.765 g dry cell weight/L after 7 days and after 32 days the cell dry weight was 10.69 g/L. It should be noted that after day 25, the dry cell weight consisted of a significant portion of dead cell mass. This is in line with what can be observed in FIG. 28, as around day 25 the culture goes from the stationary phase to the death phase.

As mentioned previously, the biomass generated in the system has the potential to be used as fuel source. Knowing that Spirulina platensis has a gross energy value of 20.5 MJ/kg, based on this, the energy generated per liter of reactor volume is 0.219 MJ/L (Coimbra et al. 2019). Using this rate of energy generation, for every 16.41 of reactor volume 1 kWh of energy is generated. The bioreactors planned for this process can treat in excess of 20,000 L/day, with continuous feed and harvesting. Unlike the experiment culture, the cultures gown in the industrial reactors will be kept constantly in the exponential growth phase, implying that instead of 10.69 g dry cell weight/L, based on FIG. 28, a yield of 1.33 to 3.89 g of dry cell weight/L is expected. Therefore, with an expected residency time of 24h, between 151.5 to 443 kWh can be generated per day per reactor.

Although the present disclosure describes methods and processes with operations (e.g., steps) in a certain order, one or more operations of the methods and processes may be omitted or altered as appropriate. One or more operations may take place in an order other than that in which they are described, as appropriate.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

### CONCLUSIONS

Based off the results of the growth comparative study, at elevated light intensity levels, Dunaliella tertiolecta is superior at degrading NAs, with the experiments boasting NA reductions of 95.7% and 81.5%. This is in comparison to the Spirulina platensis experiments, which showed lower NA degradation at 72.3% and 68.6%. Despite demonstrating inferior NA degradation rates, the biomass generation potential of Spirulina platensis far exceeds that of Dunaliella tertiolecta. When comparing the top experiments from both strains for NA degradation, the experiment using Spirulina platensis yielded 0.436 g cell dry weight/L. In comparison, the top experiment with Dunaliella tertiolecta yielded 0.093 g cell dry weight/L. Due to this difference in biomass generation, Spirulina platensis was selected to be the strain used in the large-scale replicate study.

In the large-scale replicate study, after 32 days, testing showed a 100% reduction of the NAs. This confirmed the ability of the Spirulina platensis at higher volumes, under simulated industry growth conditions, which included the use of gas sparging for agitation and CO2 feed, to effectively degrade the NAs in irradiated OSPW. The biomass generated, after 32 days the cell dry weight was 10.69 g/L.

Based on the results from both the comparative and final studies, the results unequivocally indicate the viability of using Dunaliella tertiolecta and Spirulina platensis for treating oil sand process-affected water, demonstrated by the complete elimination of NAs. Additionally, from the results, a substantial amount of biomass generation can be anticipated when the volume is scaled up, which is beneficial for potential fuel generation.

TABLE A1
Legend for Codified Experimental Design Factors

| | Level | | |
|---|---|---|---|
| Factor | −1 | 0 | 1 |
| Temperature (° C.) | 25 | 28.5 | 32 |
| Light Intensity (W/L) | 1.65 | 2.32 | 3 |

| | |
|---|---|
| Categorical | Level |

| | | |
|---|---|---|
| Factors | 1 | 2 |

| | | | |
|---|---|---|---|
| Media | For Block1: | For Block2: | Irradiated |
| | F/2 | Zorrouk | OSPW |

TABLE A2
Experimental Growth Conditions for Experiments in Comparative Study

| Experiment | | | Factor 1: | Factor 2: | Factor 3: |
|---|---|---|---|---|---|
| # | Algae Strain | Run # | Media | Temperature | Light Intensity |
| 38 | Dunaliella tertiolecta | 1 | Level 2 of A | 0 | 0 |
| 34 | Dunaliella tertiolecta | 2 | Level 2 of A | 0 | 0 |
| 36 | Dunaliella tertiolecta | 3 | Level 2 of A | 0 | 0 |
| 35 | Dunaliella tertiolecta | 4 | Level 1 of A | 0 | 0 |
| 25 | Dunaliella tertiolecta | 5 | Level 1 of A | 1 | 1 |
| 33 | Dunaliella tertiolecta | 6 | Level 1 of A | 0 | 0 |
| 37 | Dunaliella tertiolecta | 7 | Level 1 of A | 0 | 0 |
| 13 | Dunaliella tertiolecta | 8 | Level 2 of A | 1 | −1 |
| 14 | Dunaliella tertiolecta | 9 | Level 2 of A | 1 | −1 |
| 2 | Dunaliella tertiolecta | 10 | Level 1 of A | −1 | −1 |
| 21 | Dunaliella tertiolecta | 11 | Level 2 of A | −1 | 1 |
| 22 | Dunaliella tertiolecta | 12 | Level 2 of A | −1 | 1 |
| 5 | Dunaliella tertiolecta | 13 | Level 2 of A | −1 | −1 |
| 1 | Dunaliella tertiolecta | 14 | Level 1 of A | −1 | −1 |
| 30 | Dunaliella tertiolecta | 15 | Level 2 of A | 1 | 1 |
| 26 | Dunaliella tertiolecta | 16 | Level 1 of A | 1 | 1 |
| 17 | Dunaliella tertiolecta | 17 | Level 1 of A | −1 | 1 |
| 6 | Dunaliella tertiolecta | 18 | Level 2 of A | −1 | −1 |
| 9 | Dunaliella tertiolecta | 19 | Level 1 of A | 1 | −1 |
| 18 | Dunaliella tertiolecta | 20 | Level 1 of A | −1 | 1 |
| 10 | Dunaliella tertiolecta | 21 | Level 1 of A | 1 | −1 |
| 29 | Dunaliella tertiolecta | 22 | Level 2 of A | 1 | 1 |
| 44 | Spirulina platensis | 23 | Level 2 of A | 0 | 0 |
| 24 | Spirulina platensis | 24 | Level 2 of A | −1 | 1 |
| 16 | Spirulina platensis | 25 | Level 2 of A | 1 | −1 |
| 41 | Spirulina platensis | 26 | Level 1 of A | 0 | 0 |
| 31 | Spirulina platensis | 27 | Level 2 of A | 1 | 1 |
| 15 | Spirulina platensis | 28 | Level 2 of A | 1 | −1 |
| 39 | Spirulina platensis | 29 | Level 1 of A | 0 | 0 |
| 7 | Spirulina platensis | 30 | Level 2 of A | −1 | −1 |
| 4 | Spirulina platensis | 31 | Level 1 of A | −1 | −1 |
| 42 | Spirulina platensis | 32 | Level 2 of A | 0 | 0 |
| 11 | Spirulina platensis | 33 | Level 1 of A | 1 | −1 |
| 40 | Spirulina platensis | 34 | Level 2 of A | 0 | 0 |
| 43 | Spirulina platensis | 35 | Level 1 of A | 0 | 0 |
| 27 | Spirulina platensis | 36 | Level 1 of A | 1 | 1 |
| 12 | Spirulina platensis | 37 | Level 1 of A | 1 | −1 |
| 28 | Spirulina platensis | 38 | Level 1 of A | 1 | 1 |
| 3 | Spirulina platensis | 39 | Level 1 of A | −1 | −1 |
| 23 | Spirulina platensis | 40 | Level 2 of A | −1 | 1 |
| 20 | Spirulina platensis | 41 | Level 1 of A | −1 | 1 |
| 19 | Spirulina platensis | 42 | Level 1 of A | −1 | 1 |
| 8 | Spirulina platensis | 43 | Level 2 of A | −1 | −1 |
| 32 | Spirulina platensis | 44 | Level 2 of A | 1 | 1 |

TABLE A3
Cell Count Results for Growth Comparative Study Experiments

| | Algae | 10⁴ |
|---|---|---|
| Experiment | Strain | Cells/mL |
| Experiment 1 | Dunaliella | 45.5 |
| | tertiolecta | |
| Experiment 2 | Dunaliella | 47 |
| | tertiolecta | |
| Experiment 3 | Spirulina | 19 |
| | platensis | |
| Experiment 4 | Spirulina | 17.5 |
| | platensis | |
| Experiment 5 | Dunaliella | 21.5 |
| | tertiolecta | |
| Experiment 6 | Dunaliella | 37 |
| | tertiolecta | |
| Experiment 7 | Spirulina | 23.5 |
| | platensis | |
| Experiment 8 | Spirulina | 21.5 |
| | platensis | |
| Experiment 9 | Dunaliella | 35 |
| | tertiolecta | |
| Experiment 10 | Dunaliella | 37 |
| | tertiolecta | |
| Experiment 11 | Spirulina | 20.5 |
| | platensis | |
| Experiment 12 | Spirulina | 20.5 |
| | platensis | |
| Experiment 13 | Dunaliella | 12 |
| | tertiolecta | |
| Experiment 14 | Dunaliella | 2 |
| | tertiolecta | |
| Experiment 15 | Spirulina | 22.5 |
| | platensis | |
| Experiment 16 | Spirulina | 21.5 |
| | platensis | |
| Experiment 17 | Dunaliella | 41 |
| | tertiolecta | |
| Experiment 18 | Dunaliella | 49.5 |
| | tertiolecta | |
| Experiment 19 | Spirulina | 17.5 |
| | platensis | |
| Experiment 20 | Spirulina | 17.5 |
| | platensis | |
| Experiment 21 | Dunaliella | 17 |
| | tertiolecta | |
| Experiment 22 | Dunaliella | 18 |
| | tertiolecta | |
| Experiment 23 | Spirulina | 21.5 |
| | platensis | |
| Experiment 24 | Spirulina | 19 |
| | platensis | |
| Experiment 25 | Dunaliella | 65 |
| | tertiolecta | |
| Experiment 26 | Dunaliella | 59 |
| | tertiolecta | |
| Experiment 27 | Spirulina | 34 |
| | platensis | |
| Experiment 28 | Spiridina | 30 |
| | platensis | |
| Experiment 29 | Dunaliella | 8 |
| | tertiolecta | |
| Experiment 30 | Dunaliella | 5 |
| | tertiolecta | |
| Experiment 31 | Spirulina | 28 |
| | platensis | |
| Experiment 32 | Spirulina | 31 |
| | platensis | |
| Experiment 33 | Dunaliella | 45.5 |
| | tertiolecta | |
| Experiment 34 | Dunaliella | 2 |
| | tertiolecta | |
| Experiment 35 | Dumnaliella | 44 |
| | tertiolecta | |
| Experiment 36 | Dunaliella | 4.5 |
| | tertiolecta | |
| Experiment 37 | Dunaliella | 50 |
| | tertiolecta | |
| Experiment 38 | Dunaliella | 1 |
| | tertiolecta | |
| Experiment 39 | Spirulina | 32 |
| | platensis | |
| Experiment 40 | Spirulina | 25 |
| | platensis | |
| Experiment 41 | Spirulina | 27 |
| | platensis | |
| Experiment 42 | Spirulina | 22 |
| | platensis | |
| Experiment 43 | Spirulina | 25 |
| | platensis | |
| Experiment 44 | Spirulina | 23 |
| | platensis | |

### REFERENCES

Afonso, M. D., Jaber, J. O., & Mohsen, M. S. (2004). Brackish groundwater treatment by reverse osmosis in Jordan. Desalination, 164(2), 157-171.
El-Monem Ahmed Abd; Gharieb Mohamed; Doman Khalil. “Chemical Constituents of Zarrouk Medium Affect Growth, Pigments and Metabolites Productions of Spirulina platensis”. Egyptian Journal of Botany, 2019. doi: 10.21608/ejbo.2019.6052.1245
Allen, E. W. (2008). Process water treatment in Canada's oil sands industry: II. A review of emerging technologies. Journal of Environmental Engineering and Science, 7(5), 499-524.
Anisimov, S. I., & Orlov, N. S. (2018). Study of Mass Transfer during Reverse-Osmosis Demineralization of Dilute Solutions of Strong Electrolytes. Petroleum Chemistry, 58(13), 1107-1112.
Canada, Natural Resources. “Government of Canada.” Natural Resources Canada, /Gouvernement Du Canada, 6 Oct. 2020, www.nrcan.gc.ca/science-data/data-analysis/energy-data-analysis/energy-facts/crude-oil-facts/20064.
Cabrera, S. C. M. (2008). Characterization of Oil Sands Tailings Using Low Field Nuclear Magnetic Resonance (NMR) Technique. Master of Science dissertation, UNIVERSITY OF CALGARY
“Celebrating 50 Years of HPLC.” ChemistryViews, Wiley-VCH Verlag GmbH & Co. KGaA, 4 Jul. 2016, www.chemistryviews.org/details/news/9514801/Celebrating_50_Years_of_HPLC.html.
“Cell Counting with a Hemocytometer.” The Privalsky Lab @UCDavis, UC Davis, microbiology.ucdavis.edu/privalsky/hemocytometer.
Coimbra, Ricardo N., et al. “Comparative Thermogravimetric Assessment on the Combustion of Coal, Microalgae Biomass and Their Blend.” Energies, vol. 12, no. 15, 2019, p. 2962, doi:10.3390/en12152962.
Choudhury, A., Wilson, T. E., & Bandopadhyay, S. (2011). Reverse osmosis as a pre-treatment for aqueous phase of mine plant tailings for submarine disposal. International Journal of Mining, Reclamation and Environment, 25(2), 126-132.
Dalmia, Avinash. Analysis of Naphthenic Acids in Filtered Oil Sands Process Water (OSPW) Using LC/TOF with No Sample Preparation. PerkinElmer Inc., 2013, resources.perkinelmer.com/lab-solutions/resources/docs/APP_Analysis_of_Nalphthenic_Acids.pdf.
Eriksson, M. (2005). Ozone chemistry in aqueous solution—Ozone decomposition and stabilization. Department of Chemistry Royal Institute of Technology Stockholm, Sweden, 2005.
FAO. 2020. The State of Food and Agriculture 2020. Overcoming water challenges in agriculture. Rome.
Gehringer, P., & Eschweiler, H. (1999). Ozone/electron beam process for water treatment: design, limitations and economic considerations. Ozone: science & engineering, 21(5), 523-538.
Hewitt, L. Mark, et al. “Advances in Distinguishing Groundwater Influenced by Oil Sands Process-Affected Water (OSPW) from Natural Bitumen-Influenced Groundwaters.” Environmental Science & Technology, vol. 54, no. 3, 2020, pp. 1522-1532, doi:10.1021/acs.est.9b05040.
“History of the Hemacytometer.” Nexcelom Bioscience, Nexcelom Bioscience, 2 Feb. 2021, www.nexcelom.com/applications/cellometer/cell-counting/history-of-the-hemacytometer/.
Hu, Y., Feng, S., Yuan, Z., Xu, C. C., & Bassi, A. (2017). Investigation of aqueous phase recycling for improving bio-crude oil yield in hydrothermal liquefaction of algae. Bioresource technology, 239, 151-159.
Huang, Y., Chen, Y., Xie, J., Liu, H., Yin, X., & Wu, C. (2016). Bio-oil production from hydrothermal liquefaction of high-protein high-ash microalgae including wild Cyanobacteria sp. and cultivated Bacillariophyta sp. Fuel, 183, 9-19.
Jiang, S., Li, Y., & Ladewig, B. P. (2017). A review of reverse osmosis membrane fouling and control strategies. Science of the Total Environment, 595, 567-583.
Johnson, R. J., Smith, B. E., Sutton, P. A., McGenity, T. J., Rowland, S. J., & Whitby, C. (2011). Microbial biodegradation of aromatic alkanoic naphthenic acids is affected by the degree of alkyl side chain branching. The ISME journal, 5(3), 486.
Kean, Sam. “Eco-Alchemy in Alberta.” Science, American Association for the Advancement of Science, 20 Nov. 2009, https://science.sciencemag.org/content/326/5956/1052.
Ketenoglu, O., & Tekin, A. (2015). Applications of molecular distillation technique in food products. Italian Journal of Food Science, 27(3), 277-281.
Kim, J. S. (2015). Production, separation and applications of phenolic-rich bio-oil-a review. Bioresource technology, 178, 90-98.
Knoot, C. J., Ungerer, J., Wangikar, P. P., & Pakrasi, H. B. (2018). Cyanobacteria: promising biocatalysts for sustainable chemical production. Journal of Biological Chemistry, 293(14), 5044-5052.
Koester, Vera. “What Is HPLC?” ChemistryViews, Wiley-VCH Verlag GmbH & Co. KGaA, 20 Jun. 2016, www.chemistryviews.org/details/education/9464911/What_is_HPLC.html.
Kultschar, Bethan, and Carole Llewellyn. “Secondary Metabolites in Cyanobacteria.” IntechOpen, IntechOpen, 5 Sep. 2018, https://www.intechopen.com/books/secondary-metabolites-sources-and-applications/secondary-metabolites-in-cyanobacteria.
Le Caër, S. (2011). Water radiolysis: influence of oxide surfaces on H2 production under ionizing radiation. Water, 3(1), 235-253.
Loomba, Varun, et al. “Single-Cell Computational Analysis of Light Harvesting in a Flat-Panel Photo-Bioreactor.” Biotechnology for Biofuels, BioMed Central, 26 May 2018, www.ncbi.nlm.nih.gov/pmc/articles/PMC5970501/.
Marsh, H., & Reinoso, F. R. (2006). Activated carbon. Elsevier.
Morandi, Garrett, et al. Assessing Effects of Dissolved Organic Chemicals in OSPW by Use of the Fathead Minnow Reproductive Bioassay. University of Saskatchewan, www.usask.ca/toxicology/jgiesy/What's New/SETAC PNC June 2016/GDM_PNC_2016-v3.pdf.
NIST/SEMATECH e-Handbook of Statistical Methods, http://www.itl.nist.gov/div898/handbook/, 2013.
Orbitrap Quantitation: Lab of the Future Close Your Uncertainty Gap with the Selectivity and Confidence of HRAM. ThermoFisher Scientific, 2018, tools.thermofisher.com/content/sfs/brochures/AI-64645-LC-MS-Orbitrap-Quantitation-A164645-EN.pdf.
One Trillion Litres of Toxic Waste and Growing: Alberta's Tailings Ponds. Natural Resource Defense Council (NRDC), 2020, www.nrdc.org/sites/default/files/media-uploads/albertatailingspondsreportfinal.pdf.
Leveraging Photosynthesis for a Micro-Algae Based Bio-Economy, PondTechnologies, 2020. https://www.pondtech.com/wp-content/uploads/2020/11/Pond-Tech-Company-Presentation-October-2020-1.pdf
Quagraine, E. K., Peterson, H. G., & Headley, J. V. (2005). In situ bioremediation of naphthenic acids contaminated tailing pond waters in the Athabasca oil sands region-demonstrated field studies and plausible options: a review. Journal of Environmental Science and Health, 40(3), 685-722.
Quesnel, D. M., Bhaskar, I. M., Gieg, L. M., & Chua, G. (2011). Naphthenic acid biodegradation by the unicellular alga Dunaliella tertiolecta. Chemosphere, 84(4), 504-511.
Saidi-Mehrabad, A., He, Z., Tamas, I., Sharp, C. E., Brady, A. L., Rochman, F. F., & Sensen, C. W. (2013). Methanotrophic bacteria in oilsands tailings ponds of northern Alberta. The ISME journal, 7(5), 908
Scott, A. C., Mackinnon, M. D., & Fedorak, P. M. (2005). Naphthenic acids in Athabasca oil sands tailings waters are less biodegradable than commercial naphthenic acids. Environmental science & technology, 39(21), 8388-8394.
Seepratoomrosh, Jitpisut, et al. “The Effect of Light Stress and Other Culture Conditions on Photoinhibition and Growth of Dunaliella tertiolecta.” Applied Biochemistry and Biotechnology, vol. 178, no. 2, 2015, pp. 396-407., doi:10.1007/s12010-015-1882-x.
Shanmugam, S. R., Adhikari, S., Wang, Z., & Shakya, R. (2017). Treatment of aqueous phase of bio-oil by granular activated carbon and evaluation of biogas production. Bioresource technology, 223, 115-120.
Steward, Gillian. “Tailings Ponds a Toxic Legacy of Alberta's Oilsands.” Thestar.com, 4 Sep. 2015, www.thestar.com/news/atkinsonseries/2015/09/04/tailings-ponds-a-toxic-legacy-of-albertas-oilsands.html.
Suzuki, H., Yamagiwa, S., Araki, S., & Yamamoto, H. (2016). Effects of Advanced Oxidation Processes on the Decomposition Properties of Organic Compounds with Different Molecular Structures in Water. Journal of Water Resource and Protection, 8(09), 823.
Taylor, G. (2012). Fatty Acid Metabolism in Cyanobacteria, PQDT—UK & Ireland. Tedesco, M., & Duerr, A. (1989). Light, temperature and nitrogen starvation effects on the total lipid and fatty acid content and composition of Spirulina platensis UTEX 1928. Journal of Applied Phycology, 1(3), 201-209.
Terzyk, A. P. (2004). Molecular properties and intermolecular forces-factors balancing the effect of carbon surface chemistry in adsorption of organics from dilute aqueous solutions. Journal of Colloid and Interface Science, 275(1), 9-29.
“UHPLC: Ultra-High-Performance Liquid Chromatography: EAG Labs.” EAG Laboratories, Eurofins, 16 May 2019, www.eag.com/techniques/chromatography/ultra-high-performance-liquid-chromatography-uhplc/.
United Nations (2018). Sustainable Development Goal 6 Synthesis Report 2018 on Water and Sanitation. New York.
“U.S. Energy Information Administration—EIA—Independent Statistics and Analysis.” Canada's Oil Production Drops to Its Lowest Level since 2016 Wildfires—Today in Energy—U.S. Energy Information Administration (EIA), www.eia.gov/todayinenergy/detail.php?id=44396.
Vardon, D. R., Sharma, B. K., Scott, J., Yu, G., Wang, Z., Schideman, L., . . . & Strathmann, T. J. (2011). Chemical properties of biocrude oil from the hydrothermal liquefaction of Spirulina algae, swine manure, and digested anaerobic sludge. Bioresource technology, 102(17), 8295-8303.
Vargas, M. A., Rodriguez, H., Moreno, J., Olivares, H., Campo, J. D., Rivas, J., & Guerrero, M. G. (1998). Biochemical composition and fatty acid content of filamentous nitrogen-fixing cyanobacteria. Journal of Phycology, 34(5), 812-817.
Vonshak, A. (Ed.). (2014). Spirulina platensis arthrospira: physiology, cell-biology and biotechnology. CRC Press.
“Water and Wastewater Treatment Market Size, Share & COVID-19 Impact Analysis, By Segment (Chemicals {PH Conditioners, Coagulants & Flocculants, Disinfectants & Biocidal Products, Scale & Corrosion Inhibitors, Antifoam Chemicals, Other Chemicals}, Equipment {Biological, Filtration, Sludge Treatment, Disinfection, and Other Equipment}, Services), By Application (Municipal, & Industrial), and Regional Forecast, 2021-2028.” Water and Wastewater Treatment Market Size I Global Report, 2028, www.fortunebusinessinsights.com/water-and-wastewater-treatment-market-102632.
Xu, X., Pliego, G., Zazo, J. A., Sun, S., Garcia-Muhoz, P., He, L., . . . & Rodriguez, J. J. (2017). An overview on the application of advanced oxidation processes for the removal of naphthenic acids from water. Critical Reviews in Environmental Science and Technology, 47(15), 1337-1370.
Yang, C., G. Zhang, M Seman. G. Koivu. Z. Yang. B. P. Hollebone. P. G. Lambert, and C. E. Brown. Characterization of Naphthenic Acids in Crude Oils and Refined Petroleum Products, Proceedings of the Forty-first AMOP Technical Seminar, Environment and Climate Change Canada. Ottawa. ON. Canada, PP-559-575, 2018.
Yang, W., Li, X., Li, Z., Tong, C., & Feng, L. (2015). Understanding low-lipid algae hydrothermal liquefaction characteristics and pathways through hydrothermal liquefaction of algal major components: crude polysaccharides, crude proteins and their binary mixtures. Bioresource technology, 196, 99-108.
Zhang, S., Yang, X., Zhang, H., Chu, C., Zheng, K., Ju, M., & Liu, L. (2019). Liquefaction of Biomass and Upgrading of Bio-Oil: A Review. Molecules, 24(12), 2250.
(2017, June). One trillion litres of toxic waste and growing: Alberta's tailings ponds. Natural Resources Defence Council & Environmental Defence.
(2015). About Electron Beams. E-Beam Services, Inc. Cranbury, New Jersey; Lebanon, Ohio; Lafayette, Indiana.

1. A method of treating oil sands process-affected water (OSPW), the method comprising:
obtaining irradiated OSPW;
combining the irradiated OSPW with blue-green algae, green algae, or a combination thereof to form a mixture; and
applying light to the mixture.

2. The method of claim 1, wherein the blue-green algae is Spirulina platensis, and the green algae is Dunaliella tertiolecta.

3. The method of claim 2, wherein the irradiated OSPW is combined with the Spirulina platensis and/or the Dunaliella tertiolecta.

4. The method of claim 3, wherein the light is applied to the mixture at an intensity between 1.5 and 3 W/L, preferably 3 W/L.

5. (canceled)

6. The method of claim 4, further comprising heating the mixture, wherein the mixture is heated to a temperature between 25 and 35° C. preferably 32° C.

7. (canceled)

8. (canceled)

9. (canceled)

10. (canceled)

11. (canceled)

12. (canceled)

13. (canceled)

14. (canceled)

15. (canceled)

16. (canceled)

17. The method of claim 1, wherein obtaining the irradiated OSPW comprises irradiating oil sand-process affected water.

18. The method of claim 17, wherein the irradiation applied is gamma radiation and/or electron-beam irradiation.

19. (canceled)

20. The method of claim 18, further comprising ozonating the OSPW.

21. The method of claim 1, wherein naphthenic acids in the OSPW are biodegraded.

22. The method of claim 1, wherein biomass of the blue-green algae and/or the green algae is generated.

23. Use of blue-green algae, green algae, or a combination thereof to treat irradiated oil sands process-affected water (OSPW).

24. The use of claim 23, wherein the blue-green algae, the green algae, or the combination thereof is combined with the irradiated OSPW in a mixture, and light is applied to the mixture.

25. The use of claim 24, wherein the blue-green algae is Spirulina platensis, and the green algae is Dunaliella tertiolecta.

26. The use of claim 25, wherein the Spirulina platensis and/or the Dunaliella tertiolecta is combined with the irradiated OSPW.

27. The use of claim 26, wherein the light is applied to the mixture at an intensity between 1.5 and 3 W/L, preferably 3 W/L.

28. (canceled)

29. The use of claim 27, wherein the mixture is heated to a temperature between 25 and 35° C., preferably 32° C.

30. (canceled)

31. (canceled)

32. (canceled)

33. (canceled)

34. (canceled)

35. (canceled)

36. The use of claim 25, wherein the combination of Spirulina platensis and Dunaliella tertiolecta is combined with the irradiated OSPW.

37. The use of claim 36, wherein the light is applied to the mixture at an intensity between 1.5 and 3 W/L, preferably 3 W/L.

38. (canceled)

39. The use of claim 37, wherein the mixture is heated to a temperature between 25 and 35° C.

40. The use of claim 23, wherein the irradiated OSPW was irradiated with gamma radiation and/or electron-beam irradiation.

41. (canceled)

42. The use of claim 40, wherein the irradiated OSPW was ozonated.

43. The use of claim 23 to biodegrade naphthenic acids in the irradiated OSPW.

44. The use of claim 23 to generate biomass of the blue-green algae and/or the green algae.
